(19) United States
(12) Patent Application Publication
(10) Pub. No.: US 2009/0202935 A1
(43) Pub. Date: Aug. 13, 2009

(54) CARRIER, TWO-COMPONENT DEVELOPER CONTAINING CARRIER AND TONER, AND IMAGE FORMING METHOD

(76) Inventors: Yoshihiro Moriya, Numazu-shi (JP); Keishi Taniguchi, Susono-shi (JP); Akihiro Kotsugai, Numazu-shi (JP); Ryota Inoue, Mishima-shi (JP); Shingo Sakashita, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/366,285

(22) Filed: Feb. 5, 2009

(30) Foreign Application Priority Data
Feb. 13, 2008 (JP) 2008-031457
Mar. 26, 2008 (JP) 2008-080037

(51) Int. Cl. G03G 13/20; G03G 9/107; G03G 9/087; G03G 9/08

(52) U.S. Cl. 430/109.4; 430/111.35; 430/110.4; 430/124.1

(57) ABSTRACT

A carrier including magnetic core particles and a coating layer, wherein the coating layer is formed by applying a coating liquid containing at least colloidal silica, a condensate of alkoxysilane represented by General Formula (1) and a solvent onto the core particles; an amount of colloidal silica contained in the coating layer is less than 60% by mass; and a ratio (h/Dw) of a thickness (h) of the coating layer to a weight average particle diameter (Dw) of the carrier is more than 0.01, wherein the carrier is used in a two-component developer together with a toner produced through aqueous granulation and containing at least a colorant, a binder resin and a releasing agent, and wherein an amount of the releasing agent present in a region from a surface of the toner to a depth of 0.3 μm is less than 4% by mass as measured through FTIR-ATR spectroscopy.

### BACKGROUND OF THE INVENTION

1. Field of the Invention

The present invention relates to a carrier used in a two-component developer which is used for developing a latent electrostatic image and which is used for image formation in electrostatic copying processes in copiers, facsimiles, printers, etc.; to a developer containing the carrier; and to an image forming method using the two-component developer.

2. Description of the Related Art

Conventionally, two-component developing devices and one-component developing devices have been known as image forming apparatuses such as electrophotographic copying devices. The two-component developing devices use a two-component developer containing a toner and a magnetic carrier for developing a latent electrostatic image. Meanwhile, the one-component developing devices use only a toner for developing.

In general, the two-component developing devices have therein a magnetic roller formed of a magnetic material having a plurality of magnetic poles, and a rotatable, hollow-cylindrical magnetic sleeve serving as a developer-carrier (developer bearing member). This developing sleeve adsorbs a two-component developer for developing a latent electrostatic image (i.e., carrier to which a toner has adhered) in the form of magnetic brush, and then moves to a development region facing an image bearing member to perform developing.

In the two-component developing devices, a toner and a carrier for developing a latent electrostatic image are charged through stirring/mixing and thus, the chargeability of the toner becomes stable, relatively consistently forming an excellent image.

Meanwhile, various attempts have been made to improve properties of a carrier. For example, a coating layer is formed on the carrier surface for the purposes of preventing toner spent on the carrier surface, making the carrier surface uniform, preventing the carrier surface from oxidization, preventing decrease in humidity sensitivity, extending a service life of the formed developer, preventing the carrier from adhering to the photoconductor surface, preventing a photoconductor from scratch formation or abrasion, controlling charging polarity and/or adjusting the charging amount. In general, the coating layer is made of a resin material and has high strength.

Hitherto, there have been disclosed various forming methods for the coating layer; e.g., a method in which a specific resin material is used for coating (see Japanese Patent Application Laid-Open (JP-A) No. 58-108548), a method in which various additives are incorporated into a coating layer (see JP-A Nos. 54-155048, 57-40267, 58-108549 and 59-166968, Japanese Patent Application Publication (JP-B) Nos. 01-19584 and 03-628, and JP-A 06-202381), a method in which an additive is made to adhere to the carrier surface (see JP-A No. 05-273789), and a method in which conductive particles each having a particle diameter larger than the layer thickness are incorporated into a coating layer (see JP-A 09-160304). In addition, JP-A No. 08-6307 discloses that a carrier coating layer is formed by mainly using a benzoguanamine-n-butyl alcohol-formaldhyde copolymer. Furthermore, Japanese Patent (JP-B) No. 2683624 discloses a carrier coating layer formed from a crosslinked product formed between a melamine resin and an acrylic resin.

However, the carrier produced with any of the above proposed methods has insufficient durability and also, is not sufficiently prevented from adhering to the photoconductor surface. Specifically, the carrier poses problems as to its durability in that, for example, the chargeability becomes unstable in accordance with the occurrence of toner spent on the carrier surface; the resistivity decreases with decreasing of the thickness of the coat layer due to abrasion; and the quality of a printed image gradually degrades in accordance with increase of running in number, although an excellent image can be obtained in an initial state. Thus, the carrier must be improved.

Conventionally, a coating layer is made of resin with a low surface energy (e.g., silicone resin) in order to prevent, among others, toner spent on the carrier surface. The coating layer formed of such a resin, however, decreases in adhesiveness not only to toner particles but also to carrier core particles. Thus, although use thereof prevents toner spent on the carrier surface, delamination of the carrier coating layer (silicone resin) is promoted to expose the carrier core particles, resulting in decrease in resistivity.

In order to overcome the above-described problem, JP-A No. 2006-058811 suggests formation of a so-called dual carrier coating layer; i.e., a method in which carrier core particles are coated with an acrylic resin having high adhesiveness thereto, and then the formed acrylic resin layer is coated with a silicone resin having low surface energy.

Also, JP-A Nos. 08-234501 and 2000-235283 suggest that an acryl-modified silicone resin, which has excellent properties of both an acrylic resin and a silicone resin, is used for forming a coating layer, to thereby improve its chargeability and adhesiveness to core particles, and prevent the occurrence of toner spent.

The above-described methods can form a coating layer having more excellent properties than that formed by a conventional method. However, demand has arisen for a further improved coating layer in order to meet more strict requirements for durability of recent developers. In particular, even when the formed coating layer exhibits excellent adhesiveness to carrier core particles and prevents the occurrence of toner spent, degradation of the coating layer is caused by stress applied during stirring. Thus, there is a need to form a more durable coating layer by, for example, positively enhancing mechanical strength of a coated resin.

Under such circumstances, there is proposed a carrier having improved durability and anti-toner-filming property, the carrier being produced by providing the surface of carrier core particles with a coating layer containing a metal oxide formed through the sol-gel process and organoalkoxysilane and/or a coupling agent (see JP-A No. 2002-196541).

As described in Examples of this Patent Literature, the coating layer mainly contains an oxide of Zn or Zr, and the layer strength is attributed to the metal oxide.

This coating layer containing the metal oxide prevents toner spent, and exhibits required adhesiveness to carrier core particles and improved layer strength. However, when the thickness thereof becomes large, excessively existing metal oxides may cause the coating layer to easily cause toner spent and crack formation, resulting in problematic abrasion and/or delamination thereof.

### BRIEF SUMMARY OF THE INVENTION

The present invention aims to solve the problems pertinent in the art and achieve the following objects. Specifically, an object of the present invention is to provide a carrier used in a two-component developer (hereinafter the carrier used in a two-component developer may be referred to simply as a “carrier”), the carrier having a carrier coating layer firmly adhering to core particles, involving no change in chargeability caused by toner spent and/or abrasion of the carrier coating layer after long-term stirring, and forming an image having image quality almost equivalent to initial image quality even after repetitive use; a two-component developer containing the carrier and a toner; and an image forming method using the two-component developer.

The toner used in combination with the carrier of the present invention is produced through aqueous granulation and contains at least a colorant, a binder resin and a releasing agent.

Hereinafter, a carrier coating layer and core particles may be referred to simply as a “coating layer” and “cores”, respectively.

In order to solve the above-described problems, the present inventors carried out extensive studies and have found that, when a coating liquid containing a specific amount (ratio) of colloidal silica, a condensate of alkoxysilane whose condensate having a controlled molecular weight, and a solvent is applied onto magnetic core particles to form a carrier coating layer having a predetermined thickness, to thereby produce a carrier used in a two-component developer together with a toner which is produced through aqueous granulation and contains at least a colorant, a binder resin, and a releasing agent exposed on the toner surface in a predetermined surface area, the carrier exhibits reduced toner spent and layer abrasion, and thus exhibits small change in chargeability over time.

The carrier of the present invention, therefore, can provide a highly durable two-component developer involving reduced toner spent and consistently forming a high-quality image over a long period of time. The present invention has been accomplished on the basis of the finding obtained by the present inventors, and means for solving the above problems are as follows.

<1> A carrier including:

core particles composed of a magnetic material, and

a coating layer formed on surfaces of the core particles,

wherein the coating layer is formed by applying a coating liquid containing at least colloidal silica, a condensate of alkoxysilane represented by the following General Formula (1) and a solvent onto the surfaces of the core particles; an amount of colloidal silica contained in the coating layer is less than 60% by mass; and a ratio (h/Dw) of a thickness (h) of the coating layer to a weight average particle diameter (Dw) of the carrier is more than 0.01,

wherein the carrier is used in a two-component developer together with a toner which is produced through aqueous granulation and contains at least a colorant, a binder resin and a releasing agent, and

wherein an amount of the releasing agent present in a region from a surface of the toner to a depth of 0.3 μm is less than 4% by mass as measured through Fourier transform infrared-attenuated total reflection (FTIR-ATR) spectroscopy,

Si(R¹)ₐ(R²)₄₋ₐ General Formula (1)

wherein R¹ represents an alkyl group having 1 to 10 carbon atoms; R² represents an alkoxy group having 1 to 10 carbon atoms, alkenyloxy group having 1 to 10 carbon atoms, acyloxy group having 1 to 10 carbon atoms or alkoxyalkoxy group having 1 to 10 carbon atoms; and a is an integer of 0, 1 or 2.

<2> The carrier according to <1> above, wherein the amount of colloidal silica contained in the coating layer is 0.5% by mass to 50% by mass.

When the amount falls within the above range, colloidal silica is more stably retained in the coating layer by the condensate of alkoxysilane. Thus, even when the thickness of the coating layer is large, cracking does not occur and abrasion resistance can be improved.

<3> The carrier according to any one of <1> and <2> above, wherein the coating liquid further contains an amino resin, an acrylic resin capable of reacting with the amino resin, and microparticles.

<4> The carrier according to <3> above, wherein an amount of the acrylic resin contained in the coating layer is 0.5% by mass to 30% by mass.

<5> The carrier according to any one of <3> and <4> above, wherein an amount of the microparticles contained in the coating layer is 1% by mass to 60% by mass.

<6> The carrier according to any one of <3> to <5> above, wherein the microparticles are microparticles whose surfaces have been treated with an aminosilane coupling agent.

<7> The carrier according to any one of <3> to <6> above, wherein the microparticles are conductive microparticles whose surfaces have been treated so as to have conductivity.

<8> The carrier according to any one of <3> to <7> above, wherein the coating liquid contains at least two types of microparticle.

<9> The carrier according to any one of <1> to <8> above, wherein the h/Dw satifies the relation 0.025<h/Dw<0.2.

When the h/Dw falls within this range, the formed carrier has a desired relationship between its abrasion resistance and its resistivity and thus, can form an excellent image.

<10> The carrier according to any one of <1> to <9> above, having a weight average particle diameter Dw of 20 μm to 65 μm.

When the weight average particle diameter Dw of the carrier falls within this range, the carrier can be more reliably prevented from adhering to a latent electrostatic image bearing member (from carrier scattering) and does not involve, for example, formation of streaks caused by the carrier. As a result, an image having higher image quality can be formed.

<11> The carrier according to any one of <1> to <10> above, wherein the condensate of alkoxysilane represented by General Formula (1) has a molecular weight of 1,000 or lower.

When the molecular weight of the condensate of alkoxysilane is adjusted to 1,000 or lower, a coating liquid having desirably controlled viscosity can be prepared. Such a coating liquid can easily achieve uniform coating on core particles, and also attain excellent abrasion resistance.

<12> The carrier according to any one of <1> to <11> above, wherein the coating layer is formed by applying onto surfaces of the core particles a coating liquid which contains an aminosilane coupling agent in addition to the colloidal silica, the condensate and the solvent.

When the coating liquid contains an aminosilane coupling agent, the charging amount of the formed carrier can be suitably controlled with respect to a toner.

13> The carrier according to any one of <1> to <12> above, wherein the carrier has a volume resistivity R of 10 Log (Ω·cm) to 16 Log (Ω·cm) as calculated based on a resistivity r, using the following Equation (1), the resistivity r being measured when the carrier is charged into a cell having electrodes 1 and 2 which are disposed 0.2 cm apart and which each have a surface area of 2.5 cm×4 cm under application of a DC voltage of 1,000 V between the electrodes 1 and 2.

R=Log [r×(2.5 cm×4 cm)÷0.2 cm] Equation (1)

When the volume resistivity (R) falls within this range, carrier adhesion can be effectively prevented on a photoconductor surface corresponding to a non-image area, and the edge effect, by which the developed image having a high image density is formed at only the edge portions, can be effectively prevented.

<14> A two-component developer including:

the carrier according to any one of <1> to <13> above, and

a toner which is produced through aqueous granulation and contains at least a colorant, a binder resin and a releasing agent,

wherein an amount of the releasing agent present in a region from a surface of the toner to a depth of 0.3 μm is less than 4% by mass as measured through Fourier transform infrared-attenuated total reflection (FTIR-ATR) spectroscopy.

<15> The two-component developer according to <14> above, wherein the binder resin contained in the toner is a polyester resin.

<16> The two-component developer according to any one of <14> and <15>, wherein the binder resin contains a modified polyester having a substituent whose end can react with an active hydrogen-containing group.

The binder resin used in the two-component developer according to <15> or <16> above can be easily controlled in molecular weight and modified, and is also suitably used in aqueous granulation. In addition, the binder resin provides the toner with, for example, excellent low-temperature fixing property and excellent glossiness after fixing; and is remarkably compatible with the carrier of the present invention. Thus, the two-component developer containing the carrier and the toner formed from the binder resin can form a high-quality image even after long-term use.

<17> The two-component developer according to any one of <14> to <16> above, wherein the releasing agent is a wax; an amount of the wax contained in the toner is 1% by mass to 20% by mass as calculated based on a corresponding mass of an amount of heat absorbed by the wax measured through differential scanning calorimetry (DSC); and an amount of the wax present in a region from a surface of the toner to a depth of 0.3 μm is 0.1% by mass or more and less than 4% by mass as measured through Fourier transform infrared-attenuated total reflection (FTIR-ATR) spectroscopy.

When the wax content of the toner falls within this range and the amount of wax present in the toner surface falls within this range, the formed toner has desired releaseability and desired hot offset resistance, and can prevents the occurrence of toner spent.

<18> The two-component developer according to any one of <14> to <17> above, wherein the toner has a volume average particle diameter of 3 μm to 8 μm.

<19> The two-component developer according to any one of <14> to <18>, wherein the toner has a ratio of a volume average particle diameter to a number average particle diameter (volume average particle diameter/number average particle diameter) of 1.00 to 1.25.

When the volume average particle diameter falls within the range given in <18> above and the ratio falls within the range given in <19> above, the formed carrier is prevented from decreasing in chargeability even after long-term stirring and variation in the particle diameter of the toner becomes small, realizing formation of a high-definition, high-quality image.

<20> An image forming method including:

forming a latent electrostatic image on a latent electrostatic image bearing member,

developing the latent electrostatic image with use of the two-component developer according to any one of <14> to <19> to form a visible image,

transferring the visible image onto a recording medium, and

fixing the transferred image on the recording medium.

The carrier of the present invention includes core particles composed of a magnetic material, and a coating layer having a desirably controlled thickness, wherein the coating layer is formed by applying a coating liquid containing at least a specific amount (ratio) of colloidal silica, a condensate of specific alkoxysilane and a solvent onto surfaces of the core particles. As a result, adhesiveness between the coating layer and the core particles is improved. In addition, the formed carrier involves neither toner spent nor abrasion of the carrier coating layer even after long-term stirring.

The two-component developer containing this carrier and a toner which is produced through aqueous granulation and contains at least a colorant, a binder resin and a releasing agent exhibits small change in toner chargeability over a long period of time, consistently provides a high-quality image (i.e., attains reduced degradation of image quality) and achieves a long service life. Particularly when an amount of the releasing agent present in a region from a surface of the toner to a depth of 0.3 μm is controlled to a specific amount, a high-quality image can be consistently formed over a long period of time.

The two-component developer of the present invention is formed of a carrier having a coating layer with a desirably controlled thickness which carrier contains a specific amount (ratio) of colloidal silica and a condensate of specific alkoxysilane, and of a toner having a specific amount of a releasing agent (e.g., wax) (a toner having a releasing agent exposed on its surface in a predetermined surface area) and thus, exhibits small change in toner chargeability over a long period of time, consistently provides a high-quality image (i.e., attains reduced degradation of image quality) and achieves a long service life.

The image forming method of the present invention uses the two-component developer of the present invention and thus, can consistently form a high-quality image without involving degradation of image quality of the printed image even after long-term repetitive use, since the developer can be reliably charged without toner spent on the carrier surface even after long-term stirring and the coating layer formed from colloidal silica and a condensate of specific alkoxysilane is not abraded and no decreased in thickness; i.e., the carrier is not decreased in resistivity.

### BRIEF DESCRIPTION OF THE DRAWINGS

FIG. 1 is a schematic perspective view of a device for measuring the volume resistivity (R) of a carrier of the present invention.

FIG. 2 schematically shows the configuration of a process cartridge used in the present invention.

FIG. 3 schematically shows an image forming apparatus used for performing an image forming method of the present invention.

FIG. 4 schematically shows another image forming apparatus used for performing an image forming method of the present invention.

FIG. 5 schematically shows still another image forming apparatus (tandem color image forming apparatus) used for performing an image forming method of the present invention.

FIG. 6 is a partially enlarged view of the image forming apparatus shown in FIG. 5.

### DETAILED DESCRIPTION OF THE INVENTION

As described above, the carrier of the present invention includes core particles composed of a magnetic material, and a coating layer, wherein the coating layer is formed by applying a coating liquid containing at least colloidal silica, a condensate of alkoxysilane represented by the following General Formula (1) and a solvent onto surfaces of the core particles; an amount of colloidal silica contained in the coating layer is less than 60% by mass; and a ratio (h/Dw) of a thickness (h) of the coating layer to a weight average particle diameter (Dw) of the carrier is more than 0.01, wherein the carrier is used in a two-component developer together with a toner which is produced through aqueous granulation and contains at least a colorant, a binder resin and a releasing agent, and wherein an amount of the releasing agent present in a region from a surface of the toner to a depth of 0.3 μm is less than 4% by mass as measured through Fourier transform infrared-attenuated total reflection (FTIR-ATR) spectroscopy,

Si(R¹)ₐ(R²)₄₋ₐ General Formula (1)

wherein R¹ represents an alkyl group having 1 to 10 carbon atoms; R² represents an alkoxy group having 1 to 10 carbon atoms, alkenyloxy group having 1 to 10 carbon atoms, acyloxy group having 1 to 10 carbon atoms or alkoxyalkoxy group having 1 to 10 carbon atoms; and a is an integer of 0, 1 or 2.

Next will be described in sequence a carrier and a toner, which form an electrophotographic developer (so-called two-component developer) of the present invention.

Notably, those skilled in the art can easily modify/alter the present invention claimed herein to make other embodiments, but it should be understood that the modification/alteration falls within the scope of the present invention. Also, the following exemplarily describes the best mode for carrying out the present invention and should not be construed as limiting the scope of the present invention thereto.

### [Carrier]

The carrier of the present invention includes core particles (core materials) made of a magnetic material, and a carrier-coating layer (coating layer) formed on the core particles by applying a coating liquid thereon, the coating liquid containing at least colloidal silica, a condensate of an alkoxysilane represented by the above General Formula (1), and a solvent (i.e., the coating liquid being prepared by dispersing or dissolving components for the coating layer in an organic solvent).

Hereinafter, colloidal silica and a condensate of a specific alkoxysilane may be collectively referred to as a “coating layer binding material.” Note that the coating layer binding material encompasses optionally added various coupling agents (e.g., aminosilane coupling agent).

### [Core Material]

The core material is not particularly limited and can be appropriately selected from known core materials used for forming a carrier for an electrophotographic two-component developer depending on the purpose. Preferred examples thereof include ferrites, magnetites, iron and nickel. In consideration of the recent requirements for environmental protection, Mn-based ferrites, Mn—Mg-based ferrites, Mn—Mg—Sr ferrites, Cu—Zn ferrites, Li-based ferrites, and other ferrites are preferably used instead of conventionally used Cu—Zn-based ferrites.

Also, for the purposes of, for example, controlling resistivity of the core material and improving production stability, one or more other elements (e.g., Li, Na, K, Ca, Ba, Y, Ti, Zr, V, Ag, Ni, Cu, Zn, Al, Sn, Sb and Bi) may be incorporated into the core material. The amount thereof is preferably 5 atomic % or lower, 3 atomic % or lower, with respect to the total amount of metallic elements.

The core material preferably has a weight average particle diameter (Dw) of 20 μm or more from the viewpoint of preventing carrier adhesion (scattering) onto a latent electrostatic image bearing member, and preferably has a weight average particle diameter (Dw) of 100 μm or less from the viewpoint of preventing degradation of image quality; e.g., preventing formation of streaks caused by carriers. In particular, the core material preferably has a weight average particle diameter (Dw) of 20 μm to 65 μm, more preferably 20 μm to 50 μm, from the viewpoint of forming a high-quality image recently required.

The weight average particle diameter of the core material can be measured using, for example, the Microtrack particle size analyzer SRA (product of Nikkiso Co.) with the range being set to 0.7 μm to 125 μm.

### [Coating Layer]

The coating layer is formed by applying a coating liquid onto the core material.

As described above, the coating liquid contains at least colloidal silica, a condensate of alkoxysilane represented by the above General Formula (1), the molecular weight of the condensate having been controlled to 1,000 or lower, and a solvent; and, if necessary, further contains an aminosilane coupling agent, an amino resin, a binder resin having an acrylic backbone (acrylic resin) crosslinkable with the amino resin, microparticles, and other components.

Colloidal silica (i) and a condensate of alkoxysilane (ii) contained in the coating liquid have a silanol moiety (silanol group) and therefore, have condensation reactivity. Thus, when the coating liquid which have been applied onto the carrier core material at a below-described step is treated at a subsequent heating step, hydrolysis further proceeds to allow condensation reaction, for example, between (i) and (ii) to proceed, whereby a firm coating layer can be formed on the carrier.

### <Colloidal Silica>

Colloidal silica contained in the coating liquid is a colloidal dispersion in which silica microparticles having a diameter of 5 nm to 200 nm (preferably 5 nm to 40 nm) are dispersed in water or an organic solvent. Particularly preferred is a stably dispersed colloidal silica whose pH conditions has been adjusted acidic. The colloidal silica has a silanol group on its surface and thus, is reacted with a condensate of alkoxysilane (described below in detail) to form a chemically strong coating layer.

Examples of the colloidal silica include, but not limited to, SNOWTEX O, MA-ST, IPA-ST, NBA-ST, IBA-ST, EG-ST, XBA-ST, NPC-ST, DMAC-ST (these products are of NISSAN CHEMICAL INDUSTRIE, LTD.), Cataloid SN, OSCAL1132, OSCAL1232, OSCAL1332, OSCAL1432, OSCAL1532, OSCAL1632 and OSCAL1732 (these products are of Catalysts & Chemicals Industries, Co., Ltd.).

The colloidal silica content of the coating layer is preferably 60% by mass or less, particularly preferably 0.5% by mass to 50% by mass.

When the colloidal silica content deviates from the above range, colloidal silica cannot sufficiently stably retained in the coating layer by alkoxysilane serving as a binder. Particularly when a thick carrier coating layer is formed, the formed coating layer tends to involve cracking, potentially leading to degradation of abrasion resistance, which is not preferred.

### <Alkoxysilane to be Condensed>

The coating liquid used in the present invention contains a condensate of alkoxysilane represented by General Formula (1).

Examples of the alkoxysilane to be condensed include tetramethoxysilane, tetraethoxysilane, tetra-n-propoxysilane, tetraisop ropoxysilane, tetra-n-butoxysilane, tetraisobutoxysilane, methyltrimethoxysilane, methyltriethoxysilane, ethyltrimethoxysilane and isobutyltrimethoxysilane. These may be used alone or in combination. Also, partially hydrolyzed products thereof may be used.

Alternatively, the above alkoxysilane is previously hydrolyzed in a solvent optionally using a catalyst, and the formed condensate may be incorporated into the coating liquid. When the coating liquid containing the alkoxysilane having undergone no hydrolysis treatment is applied onto the carrier core material at a below-described step, the formed coating layer is difficult to have a desired thickness. In addition, reaction for forming the coating layer does not sufficiently proceed at a heating step, potentially leading to considerable degradation of abrasion resistance and toner spent-preventing property.

The solvent suitably used in the above condensation reaction must dissolve a condensate of organosiloxane. Examples of the solvent include alcohols (e.g., mathanol, ethanol, isopropanol, n-butanol, isobutanol and 3-methyl-3-methoxybutanol) and ketones (e.g., acetone, methyl ethyl ketone, mthyl isobutyl ketone, cyclohexanone, acetylacetone, methyl acetoacetate, ethyl acetoacetate, propyl acetoacetate, butyl acetoacetate, 2,4-hexan-dion and 2,4-octan-dion). Preferably, these solvents may be used in combination in an optimal mixing ratio from the viewpoints of stabilizing the product (condensate) and controlling reactivity thereof. Needless to say, they may be used alone. Optionally, water may be added to the reaction system for promoting condensation reaction.

The condensate of alkoxysilane preferably has a molecular weight of 1,000 or lower.

When the molecular weight is higher than 1,000, abrasion resistance of the formed coating layer is considerably reduced. In addition, the viscosity of the coating liquid undesirably increases, making it difficult for the coating liquid to be uniformly applied onto the core material, which is not preferred.

### <Aminosilane Coupling Agent>

If necessary, the coating liquid further contains an aminosilane coupling agent. Use of an aminosilane coupling agent can desirably control the relative charging amount of a carrier with respect to a toner. In use, below-described microparticles are surface-treated with the aminosilane coupling agent, and the thus-treated microparticles may be used. Preferred examples of the aminosilane coupling agent include those having structural formulas listed in Table 1 given below.

TABLE 1

| | Molecular |
|---|---|
| Aminosilane coupling agent | weight |
| H₂N(CH₂)₃Si(OCH₃)₃ | MW 179.3 |
| H₂N(CH₂)₃Si(OC₂H₅)₃ | MW 221.4 |
| H₂NCH₂CH₂CH₂Si(CH₃)₂(OC₂H₅) | MW 161.3 |
| H₂NCH₂CH₂CH₂Si(CH₃)(OC₂H₅)₂ | MW 191.3 |
| H₂NCH₂CH₂NHCH₂Si(OCH₃)₃ | MW 194.3 |
| H₂NCH₂CH₂NHCH₂CH₂CH₂Si(CH₃)(OCH₃)₂ | MW 206.4 |
| H₂NCH₂CH₂NHCH₂CH₂CH₂Si(OCH₃)₃ | MW 224.4 |
| (CH₃)₂NCH₂CH₂CH₂Si(CH₃)(OC₂H₅)₂ | MW 219.4 |
| (C₄H₉)₂NC₃H₆Si(OCH₃)₃ | MW 291.6 |

The aminosilane coupling agent content of the coating layer is preferably 0.001% by mass to 30% by mass, more preferably 0.001% by mass to 10% by mass, particularly preferably 0.001% by mass to 5% by mass. When the content is less than 0.001% by mass, the chargeability of the formed coating layer tends to be affected by environmental factors. In addition, production yield is likely to decrease. When the content is more than 30% by mass, the formed coating layer easily becomes brittle, potentially leading to degradation of abrasion resistance.

Use of an aminosilane coupling agent in an amount of 0.001% by mass to 10% by mass with respect to the coating layer gives the following advantageous effects: the aminosilane coupling agent can increase the charging amount of the coating layer; excessive aminosilane coupling agents can be prevented from covering the surface of microparticles; aggregation of microparticles can be promoted to form a sufficiently strong coating layer; and there can be prevented variation in image quality over time which variation is attributed to change in an ability of charging toner.

### (Amino Resin)

The amino resin may be those conventionally known in the art. In particular, guanamine and melamine are preferably used, since they can improve the carrier in charging performance and can prevent change in charging amount of the carrier which change is caused by stirring.

Also, when the charging performance of the carrier must be more appropriately controlled, at least one of guanamine and melamine may be used in combination with another amino resin.

(Acrylic Resin Crosslinkable with Amino Resin)

The carrier coating layer in the present invention is characterized by further containing an acrylic resin crosslinkable with the amino resin. The acrylic resin has low brittleness and firmly adheres to both a core material and microparticles contained in the coating layer. Thus, it can successfully prevent delamination of the coating layer, making it difficult for the coating layer to be deteriorated, i.e., abraded and/or peeled off. In this manner, the acrylic resin can keep the coating layer stable and can strongly bind the core material to the coating layer by virtue of its excellent adhesion property. In addition, it allows particles contained in the coating layer (e.g., conductive particles) to be firmly retained therein.

The acrylic resin preferably has a glass transition temperature (Tg) of 20° C. to 100° C., more preferably 25° C. to 80° C. The acrylic resin having a glass transition temperature (Tg) falling within this range has an appropriate elasticity. Thus, supposedly, impact applied on the carrier is reduced during frictionally charging of a developer, preventing breakage of the coating layer.

In the present invention, in order to stably, negatively charge toner for a long period of time, the acrylic resin is crosslinked with the amino resin. The crosslinked product formed between the acrylic resin and the amino resin has an appropriate elasticity and can be prevented from fusion (so-called blocking), which is often caused between resin particles when an acrylic resin is used alone. The acrylic resin crosslinkable with the amino resin may be those having a hydroxyl group and/or carboxyl group. More preferred are those having a hydroxyl group, from the viewpoints of, among others, improving adhesiveness between the core material and microparticles, and of increasing dispersibility of below-described microparticles. Also, the hydroxyl value thereof is preferably 10 or higher.

The amount of the acrylic resin crosslinkable with the amino resin is preferably 0.5% by mass to 30% by mass, more preferably 5% by mass to 25% by mass, with respect to the coating layer. When the amount is less than 0.5% by mass, the formed coating layer has insufficient durability; whereas when the amount is more than 30% by mass, toner spent occurs on the carrier coating layer. Both cases are not preferred, since the formed carrier undesirably changes in its charging amount over time. The ratio by mass of the amino resin to the acrylic resin crosslinked therewith is preferably 15:85 to 70:30, more preferably 30:70 to 50:50. When the ratio deviates from this range, the formed carrier cannot give sufficient charges to toner, and excessively charges toner to cause toner spent; and the formed coating layer involves cracking due to excessively existing amino resins, which is preferred.

### <Microparticles>

In addition to the above components, microparticles may be incorporated into the coating layer. Specifically, microparticles different from the above components are added to the coating liquid, and this coating liquid is applied onto a carrier core material. If the determined in consideration of the thickness of the coating layer, the strength of the coating layer can be remarkably increased.

As such microparticles, conventionally known microparticles may be used alone or in combination. Typical examples thereof include metal oxides such as silica, titanium oxide and alumina.

Among them, alumina microparticles are preferably used for negatively charging toner.

The microparticles content of the coating layer is appropriately determined in consideration of the other components forming the layer. Preferably, it is 70% by mass or lower, more preferably 1% by mass to 60% by mass. When the content is more than 70% by mass, microparticles are easily exfoliated from the formed layer, potentially leading to drop in durability thereof.

The average particle diameter of the micoparticles varies with the thickness of the formed layer and is preferably 0.01 μm to 0.7 μm. The particle diameter of the microparticles (e.g., the above metal oxides) is appropriately determined depending on the thickness of the formed layer.

As used herein, “the thickness of the formed layer” refers to a value calculated by dividing the volume of the components which form a coating layer of a carrier of a two-component developer used for developing a latent electrostatic image and which are other than microparticles (the above coating layer binding material) by the surface area of magnetic fine powder forming a core material.

The surface area of the magnetic fine powder forming a core material is measured as follows: the volume (weight) average particle diameter thereof is measured; and the surface area of a spherical object having the thus-measured diameter is calculated. The microparticles incorporated preferably have an average particle diameter 0.01 times to 1 time the thickness of the formed layer. When the average particle diameter is smaller than the length 0.01 times the thickness of the formed layer, the particles incorporated do not contribute to increase in the strength of the coating layer. Whereas when the average particle diameter is larger than the length 1 time the thickness of the formed layer, the particles tend to be exfoliated from the coating layer.

Also, in order to adjust, to an appropriate level, electrical resistivity of a carrier of the present invention used for developing a latent electrostatic image, a conductive compound may be incorporated into the coating layer binding material of a carrier. Here, the conductive compound may be those known in the art.

Examples thereof include carbon black; conductive powder of metals (e.g., ZnO and Al), SnO₂ prepared with various methods or doped with various elements; borides (e.g., TiB₂, ZnB₂ and MoB₂); silicon carbide; and conductive polymers (e.g., polyacetylene, polyparaphenylene, poly(paraphenylene sulfide) and polypyrrole).

### [Forming Method for Coating Layer]

The forming method for the coating layer may be a conventionally known method. In one forming method, a coating layer-forming liquid (coating liquid) containing at least colloidal silica, a condensate of alkoxysilane represented by General Formula (1), and a solvent is applied onto core particles serving as a core material with a spraying method, a dipping method, etc.

Also, after the coating layer has been applied/formed on carrier particles using a coating apparatus employing one method selected from the above methods, the formed carrier particles are preferably heated to allow condensation reaction to proceed in the coating layer. This heating treatment may be carried out in the same coating apparatus as has been used for forming the coating layer; or may be carried out subsequent to coating layer formation using a separately provided heating unit (e.g., a commonly-used electric furnace and a firing kiln).

The heating temperature varies with the type of components forming the coating layer (i.e., coating layer binding material mainly containing colloidal silica (i) and a condensate of alkoxysilane (ii)) and is preferably about 120° C. to about 350° C. In particular, the heating temperature is preferably lower than a temperature at which the coating layer binding material is decomposed. More preferably, the upper limit heating temperature is about 220° C. Meanwhile, the heating time is preferably about 5 min to about 120 min.

### [Physical Properties of Carrier]

The coating layer content of the carrier is preferably 5% by mass or more, more preferably 5% by mass to 10% by mass.

The ratio (h/Dw) of the thickness (h) of the coating layer to the weight average particle diameter (Dw) of the carrier is preferably more than 0.01. More preferably, the ratio h/Dw satisfies the relation 0.025<h/Dw<0.2, still more preferably the relation 0.025<h/Dw<0.1.

When the colloidal silica content of the coating layer is less than 5% by mass (in particular, less than 0.5% by mass) or the ratio h/Dw is 0.025 or less, the formed coating layer does not have sufficient strength, resulting in that delamination or abrasion may locally proceed to expose core particles. In addition, the coating liquid for forming such a coating layer may be difficult to uniformly apply onto the core particles. In contrast, when the colloidal silica content of the coating layer is more than 10% by mass (in particular, more than 50% by mass) or the ratio h/Dw is 0.2 or more, the formed coating layer has increased strength and thus is excellent in abrasion resistance. However, the formed carrier is difficult to have a desired resistivity and thus, may form an image having degraded image quality.

The thickness (h) of the coating layer can be determined as follows: coated particles are cut with a focused ion beam (FIB); the thus-formed cross-section surface is measured for layer thicknesses at 50 sites or more through transmission electron microscopy (TEM) and scanning transmission electron microscopy (STEM); and the thus-obtained values are averaged.

The measuring method for the weight average particle diameter Dw of the carrier is not particularly limited, so long as the particle size distribution thereof can be measured, and can be appropriately selected depending on the purpose. For example, the Dw can be measured with the Microtrack particle size analyzer (model HRA9320-X100).

The weight average particle diameter Dw of the carrier is preferably 20 μm to 65 μm, more preferably 20 μm to 50 μm. When the weight average particle diameter is smaller than 20 μm, uniformity of carrier core particles is reduced to cause carrier adhesion; whereas when the weight average particle diameter is larger than 65 μm, reproducibility in fine image portions degrades, resulting in that a high-definition image may not be formed.

The volume resistivity (R) of the carrier is preferably 10 Log (Ω·cm) to 16 Log (Ω·cm), more preferably 11 Log (Ω·cm) to 16 Log (Ω·cm), particularly preferably 11 Log (Ω·cm) to 15 Log (Ω·cm).

When the volume resistivity (R) is lower than 10 Log (Ω·cm), carrier adhesion occurs on the photoconductor surface corresponding to a non-image portion; whereas when the volume resistivity (R) is higher than 16 Log (Ω·cm), the image density of an image obtained after development becomes high at the edge portions: so-called edge effect is considerably observed. If necessary, the volume resistivity (R) can be controlled within the above range by adjusting the thickness of the coating layer and/or the microparticles (conductive microparticles) content thereof.

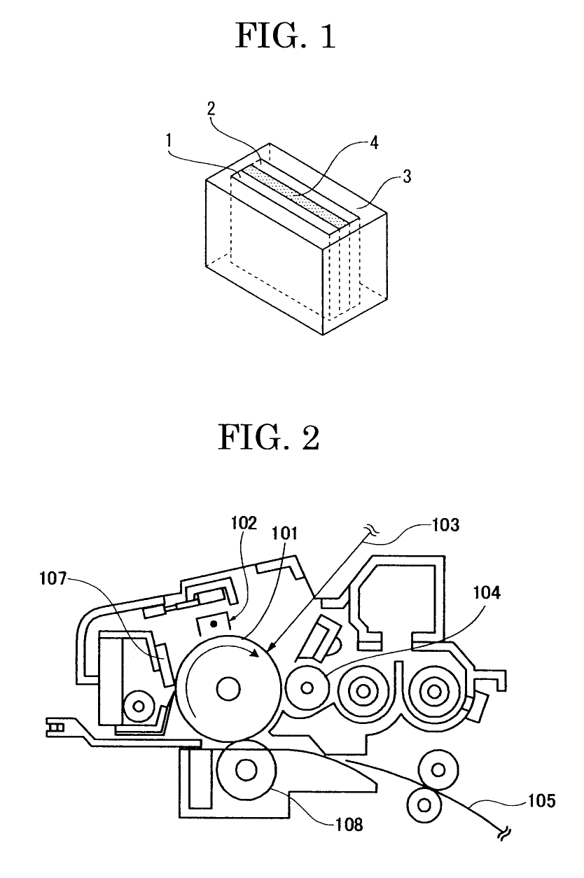

Here, the volume resistivity can be determined as follows. Specifically, carrier particles 4 are charged into a fluorine-resin cell 3 having 2.5 cm×4 cm electrodes 1 and 2 which are disposed 0.2 cm apart (shown in FIG. 1); the cell is tapped under the following conditions: fall height: 1 cm, tapping speed: 30 times/min, and the number of tappings: 10; a DC voltage of 1,000V is applied between the electrodes; a resistivity obtained after 30 sec from application of the DC voltage is measured with the high resistance meter 4329A (product of Yokokawa-HEWLETT-PACKARD); and a volume resistivtiy R Log(Ω·cm) is calculated from the obtained resistivity (r) using the following equation (1).

R=Log [r×(2.5 cm×4 cm)÷0.2 cm] Equation (1)

### [Toner]

In the present invention, a toner used in a two-component developer together with the above carrier is produced in an aqueous medium; i.e., through a so-called aqueous granulation process, and contains at least a colorant, a binder resin and a releasing agent. As the binder resin, polyester resins are preferably used.

The production process for the toner used in the present invention is not particularly limited, so long as toner production is performed in an aqueous medium, and can be appropriately selected depending on the purpose.

In one preferred process, toner materials including a compound having an active hydrogen-containing group and a polymer (e.g., modified polyester) capable of reacting therewith are dissolved or dispersed in an organic solvent; the thus-prepared toner solution is emulsified or dispersed in an aqueous medium to prepare a dispersion; and in this dispersion, the compound having an active hydrogen-containing group is reacted with the polymer capable of reacting therewith to form adhesive base particles, followed by removal of the organic solvent. This production process is preferably used, since various types of resins can be used; the obtained toner has excellent low-temperature fixing property; excellent granulation performance can be exhibited; and the toner can be easily controlled in its particle diameter, particle size distribution and shape.

The toner material used in the present invention contains at least a colorant, a releasing agent and an adhesive base (binder resin) produced through reaction between a compound having an active hydrogen-containing group and a polymer capable of reacting therewith; and, if necessary, contains other components such as a charge controlling agent and resin microparticles. The above toner materials will next be described.

### <Binder Resin>

As the binder resin, polyester resins are preferably used since the formed toner sharply melts upon fixing to smooth the image surface. In addition, even when their molecular weight is adjusted low, sufficient flexibility can be obtained. Also, the polyester resins may be used in combination with other resins. Such a polyester resin is produced through reaction between at least one of polyols represented by the following General Formula (2) and at least one of polycarboxylic acids represented by the following General Formula (3),

A-(OH)m General Formula (2)

in formula (2), A represents an alkyl group having 1 to 20 carbon atoms, an alkylene group having 1 to 20 carbon atoms, an aromatic group which may have a substituent, or a heterocyclic aromatic group which may have a substituent; and m is an integer of 2 to 4,

B—(COOH)n General Formula (3)

in formula (3), B represents an alkyl group having 1 to 20 carbon atoms, an alkylene group having 1 to 20 carbon atoms, an aromatic group which may have a substituent, or a heterocyclic aromatic group which may have a substituent; and n is an integer of 2 to 4.

Examples of the polyol represented by General Formula (2) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, bisphenol A, ethylene oxide adducts of bisphenol A, propylene oxide adducts of bisphenol A, hydrogenated bisphenol A, ethylene oxide adducts of hydrogenated bisphenol A, and propylene oxide adducts of hydrogenated bisphenol A.

Examples of polycarboxylic acids represented by General Formula (3) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isooctylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empol trimer acid, cyclohexanedicarboxylic acid, cyclohexenedicarboxylic acid, butanetetracarboxylic acid, diphenylsulfonetetracarboxylic acid, and ethylene glycolbis(trimellitic acid).

<Modified Polyester Capable of Reacting with Compound having Active Hydrogen-Containing Group>

The binder resin used in the present invention may contain a modified polyester capable of reacting with a compound having an active hydrogen-containing group. The compound having an active hydrogen-containing group serves, in aqueous granulation, as an elongating agent, a crosslinking agent, etc. for reactions of elongation, crosslinking, etc. of a polyester capable of reacting therewith.

The compound having an active hydrogen-containing group is not particularly limited and can be appropriately selected depending on the purpose. For example, when the modified polyester capable of reacting with a compound having an active hydrogen-containing group is an isocyanate group-containing modified polyester (A), an amine (B) is preferably used as the compound having an active hydrogen-containing group, since it can provide a high-molecular-weight product through reactions of elongation, crosslinking, etc. with the isocyanate group-containing modified polyester (A).

The active hydrogen-containing group is not particularly limited and can be appropriately selected depending on the purpose. Examples thereof include a hydroxyl group (alcoholic or phenolic hydroxyl group), an amino group, a carboxylic group and a mercapto group. These may be used alone or in combination. Among them, an alcoholic hydroxyl group is particularly preferred.

The amine (B) is not particularly limited and can be appropriately selected depending on the purpose. Examples thereof include diamines (B1), tri- or more-valent polyamines (B2), amino alcohols (B3), aminomercaptans (B4), amino acids (B5), and amino-blocked products (B6) of the amines (B1) to (B5). These may be used alone or in combination. Among them, particularly preferred is a mixture of the diamine (B1) and a small amount of the tri- or more-valent amine (B2).

Examples of the diamine (B1) include aromatic diamines, alicyclic diamines and aliphatic diamines. Examples of the aromatic diamine include phenylenediamine, diethyltoluenediamine and 4,4′-diaminodiphenylmethane. Examples of the alicyclic diamine include 4,4′-diamino-3,3′-dimethyldicyclohexylmethane, diaminecyclohexane and isophoronediamine. Examples of the aliphatic diamines include ethylenediamine, tetramethylenediamine and hexamethylenediamine.

Examples of the tri- or more-valent amine (B2) include diethylenetriamine and triethylenetetramine.

Examples of the amino alcohol (B3) include ethanolamine and hydroxyethylaniline.

Examples of the aminomercaptan (B4) include aminoethyl mercaptan and aminopropyl mercaptan.

Examples of the amino acid (B5) include aminopropionic acid and aminocaproic acid.

Examples of the amino-blocked product (B6) include ketimine compounds and oxazolidine compounds derived from the amines (B1) to (B5) and ketones (e.g., acetone, methyl ethyl ketone and methyl isobutyl ketone).

Also, a reaction terminator can be used for terminating elongation/crosslinking reaction between the compound having the active hydrogen-containing group and the modified polyester capable of reacting therewith.

The reaction terminator is preferably used since it can control the adhesive base material in its molecular weight, etc. to a desired level. Examples of thereof include monoamines (e.g., diethyl amine, dibutyl amine, butyl amine and lauryl amine) and blocked products thereof (e.g., ketimine compounds).

The mixing ratio of isocyanate group-containing prepolymer (A) to amine (B) is preferably 1/3 to 3/1, more preferably 1/2 to 2/1, particularly preferably 1/1.5 to 1.5/1, in terms of the equivalent ratio ([NCO]/[NHx]) of isocyanate group [NCO] in the isocyanate group-containing prepolymer (A) to amino group [NHx] in the amine (B). When the equivalent ratio ([NCO]/[NHx]) is less than 1/3, the formed toner may have degraded low-temperature fixing property;

whereas when the equivalent ratio ([NCO]/[NHx]) is more than 3/1, the molecular weight of the formed modified polyester decreases, resulting in that the formed toner may have degraded hot offset resistance.

In a modified polyester capable of reacting with a compound having an active hydrogen-containing group (hereinafter the modified polyester may be referred to as a “polyester prepolymer”), the reaction site capable of reacting with the compound having an active hydrogen-containing group is not particularly limited. Appropriately selected known substituents (moieties) may be used as the reaction site. Examples thereof include an isocyanate group, an epoxy group, a carboxyl group and an acid chloride group. These may be used alone or in combination as the reaction site. Among them, an isocyanate group is particularly preferred.

As the modified polyester, a urea bond-forming group-containing polyester resin (RMPE) is particularly preferred, since it is easily adjusted for the molecular weight of the polymeric component thereof and thus is preferably used for forming dry toner, in particular for assuring oil-less low temperature fixing property (e.g., releasing and fixing properties requiring no releasing oil-application mechanism for a heat-fixing medium).

Examples of the urea bond-forming group include an isocyanate group. Particularly preferred examples of the RMPE having an isocyanate group as the urea bond-forming group include the above isocyanate group-containing modified polyester prepolymer (A).

The backbone of the isocyanate group-containing modified polyester prepolymer (A) is not particularly limited and can be appropriately determined depending on the purpose. For example, the backbone thereof may be produced as follows: a polyol (PO) is polycondensed with a polycarboxylic acid (PC) to form a polyester having an active hydrogen-containing group; and the thus-formed polyester is reacted with a polyisocyanate (PIC). Also, it may be produced as follows: a cyclic ester and a polycondensate of a polyol (PO) and a polycarboxylic acid (PC) are subjected to ring-opening addition polymerization to form a polyester having an active hydrogen-containing group; and the thus-formed polyester is reacted with a polyisocyanate (PIC).

The polyol (PO) is not particularly limited and can be appropriately selected depending on the purpose. Examples thereof include diols (DIOs), 3 or more hydroxyl group-containing polyols (TOs), and mixtures of diols (DIOs) and 3 or more hydroxyl group-containing polyols (TOs). These may be used alone or in combination. Among them, preferred are diols (DIOs) and mixtures of diols (DIOs) and a small amount of 3 or more hydroxyl group-containing polyols (TOs).

Examples of the diol (DIO) include alkylene glycols, alkylene ether glycols, alicyclic diols, alkylene oxide adducts of alicyclic diols, bisphenols, and alkylene oxide adducts of bisphenols.

The alkylene glycol preferably is those having 2 to 12 carbon atoms, and examples thereof include ethylene glycol, 1,2-propylene glycol, 1,3-propylene glycol, 1,4-butanediol and 1,6-hexanediol. Examples of the alkylene ether glycol include diethylene glycol, triethylene glycol, dipropylene glycol, polyethylene glycol, polypropylene glycol and polytetramethylene ether glycol. Examples of the alicyclic diol include 1,4-cyclohexane dimethanol and hydrogenated bisphenol A. Examples of the alkylene oxide adducts of alicyclic diols include adducts of the above-listed alicyclic diols with alkylene oxides (e.g., ethylene oxide, propylene oxide and butylene oxide). Examples of the bisphenol include bisphenol A, bisphenol F and bisphenol S. Examples of the alkylene oxide adducts of bisphenols include adducts of the above-listed bisphenols with alkylene oxides (e.g., ethylene oxide, propylene oxide and butylene oxide).

Among them, preferred are alkylene glycols having 2 to 12 carbon atoms and alkylene oxide adducts of bisphenols, particularly preferred are alkylene oxide adducts of bisphenols, and mixtures of alkylene glycols having 2 to 12 carbon atoms and alkylene oxide adducts of bisphenols.

The 3 or more hydroxyl group-containing polyol (TO) preferably has 3 to 8 hydroxyl groups. Examples thereof include 3 or more hydroxyl group-containing aliphatic polyhydric alcohols; and 3 or more hydroxyl group-containing polyphenols and alkylene oxide adducts thereof.

Examples of the 3 or more hydroxyl group-containing aliphatic polyhydric alcohol include glycerin, trimethylolethane, trimethylolpropane, pentaerythritol and sorbitol.

Examples of the 3 or more hydroxyl group-containing polyphenol include trisphenol PA, phenol novolak and cresol novolak.

Examples of the alkylene oxide adducts include adducts of the above-listed 3 or more hydroxyl group-containing polyphenols with alkylene oxides (e.g., ethylene oxide, propylene oxide and butylene oxide).

In the mixture of the diol (DIO) and the 3 or more hydroxyl group-containing polyol (TO), the mixing ratio by mass (DIO : TO) is preferably 100:0.01 to 100:10, more preferably 100:0.01 to 100:1.

The polycarboxylic acid (PC) is not particularly limited and can be appropriately selected depending on the purpose. Examples thereof include dicarboxylic acids (DICs), polycarboxylic acids having 3 or more carboxyl groups (TCs), and mixtures of dicarboxylic acids (DICs) and polycarboxylic acids having 3 or more carboxyl groups.

These may be used alone or in combination. Among them, preferred are carboxylic acids (DICs) and mixtures of DICs and a small amount of polycarboxylic acids having 3 or more carboxyl groups (TCs).

Examples of the dicarboxylic acid include alkylene dicarboxylic acids, alkenylene dicarboxylic acids, and aromatic dicarboxylic acids.

Examples of the alkylene dicarboxylic acid include succinic acid, adipic acid and sebacic acid.

The alkenylene dicarboxylic acid is preferably those having 4 to 20 carbon atoms, and examples thereof include maleic acid and fumaric acid.

The aromatic dicarboxylic acid is preferably those having 8 to 20 carbon atoms, and examples thereof include phthalic acid, isophthalic acid, terephthalic acid, and naphthalenedicarboxylic acid.

Among them, preferred are alkenylene dicarboxylic acids having 4 to 20 carbon atoms and aromatic dicarboxylic acid having 8 to 20 carbon atoms.

The polycarboxylic acid having 3 or more carboxyl groups (TC) preferably has 3 to 8 carboxyl groups. Examples thereof include aromatic polycarboxylic acids.

The aromatic polycarboxylic acid is preferably those having 9 to 20 carbon atoms, and examples thereof include trimellitic acid and pyromellitic acid.

Alternatively, as the polycarboxylic acid (PC), there may be used acid anhydrides or lower alkyl esters of the above dicarboxylic acids (DICs), the above polycarboxylic acids having 3 or more carboxyl groups (TCs), and mixtures of the dicarboxylic acid (DICs) and the polycarboxylic acids having 3 or more carboxyl groups (TCs).

Examples of the lower alkyl ester thereof include methyl esters thereof, ethyl esters thereof and isopropyl esters thereof.

In the mixture of the dicarboxylic acid (DIC) and the polycarboxylic acid having 3 or more carboxyl groups (TC), the mixing ratio by mass (DIC : TC) is not particularly limited and can be appropriately selected depending on the purpose. Preferably, the mixing ratio (DIC: TC) is 100:0.01 to 100:10, more preferably 100:0.01 to 100:1.

In polycondensation reaction between the polyol (PO) and the polycarboxylic acid (PC), the mixing ratio of PO to PC is not particularly limited and can be appropriately selected depending on the purpose. In general, the mixing ratio PO/PC is preferably 1/1 to 2/1, more preferably 1/1 to 1.5/1, particularly preferably 1.02/1 to 1.3/1, in terms of the equivalent ratio ([OH]/[COOH]) of hydroxyl group [OH] in the polyol (PO) to carboxyl group [COOH] in the polycarboxylic acid (PC).

The polyol (PO) content of the isocyanate group-containing polyester prepolymer (A) is not particularly limited and can be appropriately determined depending on the purpose. For example, it is preferably 0.5% by mass to 40% by mass, more preferably 1% by mass to 30% by mass, particularly preferably 2% by mass to 20% by mass. When the polyol (PO) content is less than 0.5% by mass, the formed toner has degraded hot offset resistance, making it difficult for the toner to attain both desired heat resistance/storage stability and desired low-temperature fixing property. When the polyol (PO) content is more than 40% by mass, the formed toner may have degraded low-temperature fixing property.

The polyisocyanate (PIC) is not particularly limited and can be appropriately selected depending on the purpose. Examples thereof include aliphatic polyisocyanates, alicyclic polyisocyanates, aromatic diisocyanates, aromatic/aliphatic diisocyanates, isocyanurates, phenol derivatives thereof, and blocked products thereof with oxime, caprolactam, etc.

Examples of the aliphatic polyisocyanate include tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate, and tetramethylhexane diisocyanate.

Examples of the alicyclic polyisocyanate include isophorone diisocyanate and cyclohexylmethane diisocyanate.

Examples of the aromatic diisocyanate include tolylene diisocyanate, diphenylmethane diisocyanate, 1,5-naphthylene diisocyanate, diphenylene-4,4′-disocyanate, 4,4′-diisocyanato-3,3′-dimethyldiphenyl, 3-methyldiphenylmethane-4,4′-diisocyanate and diphenylether-4,4′-diisocyanate. Examples of the aromatic/aliphatic diisocyanate include α,α,α′,α′-tetramethylxylylene diisocyanate.

Examples of the isocyanurate include
tris-isocyanatoalkyl-isocyanurate and
triisocyanatoalkyl-isocyanurate.

The cyclic ester is not particularly limited, so long as it can produce a polyester through ring-opening addition polymerization. Examples thereof include L-lactide, D-lactide, DL-lactide, racemic lactide, glycoside, γ-butyrolactone, δ-valerolactone and ε-caprolactone. These cyclic esters are preferably used since they are easily available.

These may be used alone or in combination.

In reaction between the polyisocyanate (PIC) and the polyester resin having an active hydrogen-containing group (e.g., hydroxyl group-containing polyester resin), the ratio of the PIC to the polyester resin is preferably 5/1 to 1/1, more preferably 4/1 to 1.2/1, particularly preferably 3/1 to 1.5/1, in terms of the mixing equivalent ratio ([NCO]/[OH]) of isocyanate group [NCO] in the polyisocyanate (PIC) to hydroxyl group [OH] in the hydroxyl group-containing polyester resin. When the mixing equivalent ratio [NCO]/[OH] is more than 5, the formed toner may have degraded low-temperature fixing property; whereas when the mixing equivalent ratio [NCO]/[OH] is less than 1, the formed toner may have degraded offset resistance.

The polyisocyanate (PIC) content of the isocyanate group-containing polyester prepolymer (A) is not particularly limited and can be appropriately determined depending on the purpose. For example, it is preferably 0.5% by mass to 40% by mass, more preferably 1% by mass to 30% by mass, still more preferably 2% by mass to 20% by mass. Whent the polyisocyanate (PIC) content is less than 0.5% by mass, the formed toner has degraded hot offset resistance, making it difficult for the toner to attain both desired heat resistance/storage stability and desired low-temperature fixing property. When the polyisocyanate (PIC) content is more than 40% by mass, the formed toner may have degraded low-temperature fixing property.

The isocyanate group-containing polyester prepolymer (A) preferably has, in one molecule thereof, one or more isocyanate groups on average, more preferably 1.2 groups to 5 groups on average, still more preferably 1.5 groups to 4 groups on average. When the average number of the isocyanate group is less than one per one molecule, the molecular weight of the polyester resin modified with a urea bond-forming group (RMPE) decreases, resulting in that the formed toner may have degraded hot offset resistance.

The weight average molecular weight (Mw) of the polymer capable of reacting with the compound having an active hydrogen-containing group can be determined based on the molecular weight distribution obtained by analyzing tetrahydrofuran (THF) soluble matter of the polymer through gel permeation chromatography (GPC). It is preferably 3,000 to 40,000, more preferably 4,000 to 30,000. When the weight average molecular weight (Mw) is lower than 3,000, the formed toner may have degraded heat resistance/storage stability; whereas when the Mw is higher than 40,000, the formed toner may have degraded low-temperature fixing property.

The gel permeation chromatography (GPC) for determining the molecular weight can be performed, for example, as follows.

Specifically, a column is conditioned in a heat chamber at 40° C., and then tetrahydrofuran (THF) (solvent) is caused to pass through the column at a flow rate of 1 mL/min while the temperature is maintained. Subsequently, a separately prepared tetrahydrofuran solution of a resin sample (concentration: 0.05% by mass to 0.6% by mass) is applied to the column in an amount of 50 μL to 200 μL. In the measurement of the molecular weight of the sample, the molecular weight distribution is determined based on the relationship between the logarithmic value and the count number of a calibration curve given by using several monodisperse polystyrene-standard samples. The standard polystyrenes used for giving the calibration curve may be, for example, those available from Pressure Chemical Co. or Tosoh Co.; i.e., those each having a molecular weight of 6×10², 2.1×10³, 4×10³, 1.75×10⁴, 1.1×10⁵, 3.9×10⁵, 8.6×10⁵, 2×10⁶ and 4.48×10⁶. Preferably, at least about 10 standard polystyrenes are used for giving the calibration curve. The detector which can be used is a refractive index (RI) detector.

### <Colorant>

The colorant is not particularly limited and can be appropriately selected from known dyes and pigments depending on the purpose. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These may be used alone or in combination.

The colorant content is preferably 1% by mass to 15% by mass, preferably 3% by mass to 10% by mass, with respect to the toner.

The colorant may be mixed together with a resin and used as a master batch. The resin is not particularly limited and can be appropriately selected from known resins depending on the purpose. Examples thereof include polymers of substituted or unsubstituted styrene, styrene-based copolymers, polymethyl methacrylate resins, polybutyl methacrylate resins, polyvinyl chloride resins, polyvinyl acetate resins, polyethylene resins, polypropylene resins, polyester resins, epoxy resins, epoxy polyol resins, polyurethane, polyamide, polyvinyl butyral, polyacrylic acid resins, rosin, modified rosin, terpene resins, aliphatic hydrocarbon resins, alicyclic hydrocarbon resins, aromatic petroleum resins, chlorinated paraffins and paraffins.

These may be used alone or in combination.

### <Releasing Agent>

The releasing agent is not particularly limited and can be appropriately selected from those known in the art depending on the purpose. Preferred examples thereof include waxes. Examples of the wax include carbonyl group-containing waxes, polyolefin waxes and long chain hydrocarbons. These may be used alone or in combination.

Examples of the carbonyl group-containing wax include polyalkanoic acid esters, polyalkanol esters, polyalkanoic acid amides, polyalkyl amides and dialkyl ketones. Examples of the polyalkanoic acid ester include carnauba wax, montan wax, trimethylolpropane tribehenate, pentaerythritol tetrabehenate, pentaerythritol diacetate dibehenate, glycerine tribehenate and 1,18-octadecanediol distearate. Examples of the polyalkanol ester include tristearyl trimellitate and distearyl maleate. Examples of the polyalkanoic acid amide include dibehenyl amide. Examples of the polyalkyl amide include tristearyl trimellitate amide. Examples of the dialkyl ketone include distearyl ketone.

Examples of the polyolefin wax include polyethylene waxes and polypropylene waxes.

Examples of the long chain hydrocarbon include paraffin waxes and sasol waxes.

The melting point of the releasing agent is not particularly limited and can be appropriately selected depending on the purpose. It is preferably 40° C. to 160° C., more preferably 50° C. to 120° C., still more preferably 60° C. to 90° C. When the melting point is lower than 40° C., wax may adversely affect heat resistance/storage stability of the formed toner. Whereas when the melting point is higher than 160° C., the formed toner tend to involve cold offset upon fixation at low temperature.

The melt viscosity of the releasing agent is preferably 5 cps to 1,000 cps, more preferably 10 cps to 100 cps as measured at a temperature which is 20° C. higher than the melting point of the releasing agent (wax). When the melt viscosity is lower than 5 cps, the formed toner may have degraded releaseability. Whereas when the melt viscosity is higher than 1,000 cps, the formed toner may not have improved hot offset resistance and low-temperature fixing property.

In the present invention, the releasing agent (wax) content of the toner is determined as follows: the amount of heat absorbed by the wax is measured through differential scanning calorimetry (DSC); and the obtained value is reduced to a value on a mass basis. Preferably, the wax content of the toner is 1% by mass to 20% by mass.

The amount of the releasing agent (wax) present in a region from the toner surface to a depth of 0.3 μm is preferably less than 4% by mass, more preferably 0.1% by mass or more and less than 4% by mass, as measured through Fourier transform infrared-attenuated total reflection (FTIR-ATR) spectroscopy.

As described below in detail, the releasing agent (wax) content (total wax content) of the toner is measured based on the ratio of the amount of heat absorbed by the wax contained in the toner to the amount of heat absorbed by the corresponding raw wax.

The total wax content of toner particles is measured through differential scanning calorimetry (DSC). Specifically, a raw wax sample and a toner sample containing the wax are measured for their amount of heat absorbed using the following measuring apparatus under the following measurement conditions.
Measuring apparatus: DSC apparatus (DSC60, product of Shimadzu Corporation)
Sample amount: about 5 mg
Temperature increasing rate: 10° C./min
Measurement temperature range: room temperature to 150° C.
Measurement environment: nitrogen gas atmosphere
The total wax content was calculated using the following equation (2).

The total wax content (% by mass)=[(amount of heat absorbed by wax of the toner sample (J/g))×100/(amount of heat absorbed by raw wax (J/g))] Equation (2)

Through the above-described analysis, the total releasing agent (wax) content of the toner particles can be accurately determined, even when some of the wax outflows from toner during toner production.

Next will be described in detail a method for measuring the amount of the releasing agent (wax) present in a region from the toner surface to a predetermined depth. The amount of the releasing agent (wax) present in the vicinity of the surface of toner particles can be measured through Fourier transform infrared-attenuated total reflection (FTIR-ATR) spectroscopy. This analysis has a depth-related analytical limit of about 0.3 μm and the amount of the releasing agent (wax) present in a region from the surface of toner particles to a depth of 0.3 μm can be measured through FTIR-ATR spectroscopy. The measurement method is as follows.

Firstly, a toner of 3 g is pressed using an automatic pelletizer (Type M No. 50 BRP-E, product of MAEKAWA TESTING MACHINE CO.) at a load of 6 t for 1 min to form a pellet sample having a diameter of 40 mm (thickness: about 2 mm). The surface of the thus-formed pellet is analyzed through FTIR-ATR spectroscopy.

The microscopic FTIR apparatus used is an apparatus Spectrum One (product of PERKIN ELMER Co.) equipped with a MultiScope FTIR unit using a micro ATR of germanium (Ge) having a diameter of 100 μm. This measurement is carried out under the following conditions: the incident light angle of infrared ray: 41.5°, resolution: 4 cm⁻¹ and the number of measurements: 20.

The ratio of a peak intensity attributed to a releasing agent (wax) to a peak intensity attributed to a binder resin (828 cm⁻¹) was measured, and the relative amount of the releasing agent (wax) present in a surface of toner particles (sample) was calculated from the obtained peak intensity ratio. Each of the peak intensities was a value obtained by averaging values measured at four different points. The amount of the releasing agent (wax) present in a surface of the sample was calculated based on the relationship between the relative releasing agent (wax) amount of a sample, which had been prepared for obtaining a calibration curve by homogeneously dispersing a known amount of the releasing agent (wax) in the binder resin, and its peak intensity ratio obtained in a manner similar to the above.

Through analysis of various toners, it was found that different correlations between the total releasing agent (wax) content measured through DSC and the intensity ratio determined through FTIR-ATR spectroscopy were observed depending on different dispersion states in various toner production processes.

In the toner which is produced in an aqueous medium and contains at least a colorant, a binder resin (e.g., polyester) and a releasing agent (e.g., wax)—this toner is preferably used in the present invention—, wax does not exist in the outermost surface of each toner particle but is uniformly dispersed in the toner particle. The above correlation was investigated by changing the total wax content of the toner, and the results are as follows.

Specifically, when the total wax content is small, the amount of wax present in the vicinity of a surface of toner particles is constantly 0 as a value expressed by the intensity ratio. When the total wax content exceeds a certain value, the intensity ratio is increased. This indicates that wax is not dispersed selectively in the vicinity of a surface of toner particles but is uniformly dispersed in a region closer to the center of toner particles. Also, wax present in a region from a surface of toner particles to a depth of 0.3 μm (which is detected through FTIR-ATR spectroscopy) is easy to exude to the surface and thus, effectively imparts releaseability to the toner.

As described above, the amount of wax present in a surface of toner particles is preferably less than 4% by mass, more preferably 0.1% by mass or more and less than 4% by mass, as measured through FTIR-ATR spectroscopy.

When the amount of the wax is less than 0.1% by mass, the amount of wax present in the vicinity of toner particles is too small, resulting in failure to attain sufficient releaseability after fixing. Whereas when the amount is more than 4% by mass, the amount of wax in the vicinity of toner particles is too large and thus, the wax is easy to exude to the outermost surface. As a result, toner particles tend to adhere via the wax to a surface of carrier particles, potentially increasing the occurrence of toner spent in the developer, which is not preferred. Thus, the above range is preferred in order to achieve both desired hot offset resistance during fixing and desired other properties such as chargeability, developability and toner spent-preventing property. Particularly preferably, the amount falls within a range of 0.1% by mass to 3% by mass.

The total releasing agent (wax) content of toner particles is preferably 0.5% by mass to 20% by mass, more preferably 1% by mass to 20% by mass, as measured through DSC as described above.

When the total releasing agent (wax) content is less than 0.5% by mass, the wax content of toner particles is too low. Thus, sufficient releaseability cannot be attained after fixing, potentially reducing hot offset resistance of the formed toner. Whereas when the total releasing agent (wax) content is more than 20% by mass, the formed toner exhibits reduced toner spent-preventing property and provides a color image with low glossiness after fixing, which is not preferred.

Preferably, particles of the releasing agent (wax) are homogeneously dispersed in each toner particle. Here, “homogeneously dispersed wax particles” refer to a plurality of wax particles virtually homogeneously dispersed in each toner particle. For example, in a cross-sectional toner surface including the center of the toner particle, wax particles preferably exist in a circle having the same center and ⅔ the radius of the surface—a straight line connecting an optionally selected point on its circumference with its center—at a ratio of higher than 30% and 60% or lower with respect to the total wax particles on a mass basis. The exposed area of wax on the outermost surface of toner particles is preferably 5% or lower of the surface area thereof.

The volume average particle diameter of the releasing agent (wax) is not particularly limited and can be appropriately determined depending on the purpose. Preferably, the releasing agent (wax) has a small volume average particle diameter. For example, it is preferably 0.1 μm to 2 μm, more preferably 0.1 μm to 1 μm. When the volume average particle diameter is less than 0.1 μm, the formed toner cannot exhibit sufficient releaseability; whereas when the volume average particle diameter is more than 2 μm, the wax may not homogeneously be dispersed in the toner particle.

### <Charge Controlling Agent>

The charge controlling agent is not particularly limited and can be appropriately selected depending on the purpose. A positive or negative charge controlling agent may be used in consideration of the charge polarity (positive or negative) of a photoconductor.

Examples of the negative charge controlling agent include resins or compounds having an electron donating functional group, azo dyes and metal complexes of organic acids. Specific examples thereof include BONTRON (Cat. Nos.: S-31, S-32, S-34, S-36, S-37, S-39, S-40, S-44, E-81, E-82, E-84, E-86, E-88, A, 1-A, 2-A and 3-A) (these products are of Orient Chemical Industries, Ltd.); Kayacharge (Cat. Nos.: N-1 and N-2), Kayaset Black (Cat. No.: T-2 and 004) (these products are of NIPPON KAYAKU CO., LTD.); AIZEN SPIRON BLACK (T-37, T-77, T-95, TRH and TNS-2) (these products are of HODOGAYA CHEMICAL CO., LTD.); FCA-1001-N, FCA-1001-NB and FCA-1001-NZ (these products are of FUJIKURA KASEI CO., LTD.).

Examples of the positive charge controlling agent include basic compounds (e.g., nigrosine dyes), cationic compounds (e.g., quaternary ammonium salts) and metal salts of higher fatty acids. Specifica examples thereof include BONTRON (Cat. Nos.: N-01, N-02, N-03, N-04, N-05, N-07, N-09, N-10, N-11, N-13, P-51, P-52, AFP-B) (these products are of Orient Chemical Industries, Ltd.); TP-302, TP-415, TP-4040 (these products are of HODOGAYA CHEMICAL CO., LTD.); COPY BLUE PR, COPY CHARGE (Cat. Nos.: PX-VP-435 and NX-VP-434) (these products are of Hoechst AG); FCA (Cat. Nos.: 201, 201-B-1, 201-B-2, 201-B-3, 201-PB, 201-PZ, 301) (these products are of FUJIKURA KASEI CO., LTD.); and PLZ (Cat. Nos.: 1001, 2001, 6001, 7001) (these products are of SHIKOKU CHEMICALS CORPORATION).

These charge controlling agents may be used alone or in combination.

The amount of the charge controlling agent added is not determined depending on a single factor and is varied depending on the type of the binder resin used and on the toner production method used (including the dispersion method used). The amount is preferably 0.1 parts by mass to 10 parts by mass, more preferably 0.2 parts by mass to 5 parts by mass, per 100 parts by mass of the binder resin. When the amount is more than 10 parts by mass, the formed toner has too high chargeability, resulting in that the charge controlling agent exhibits reduced effects. As a result, the interacting electrostatic force increases between the developing roller and the toner, decreasing the fluidity of the toner and forming an image with reduced color density. When the amount is less than 0.1 parts by mass, the formed toner exhibits insufficient charge rising property, potentially giving adverse effects on the formed toner image.

### [Production Method for Toner]

A toner used in a two-component developer together with the carrier of the present invention is produced through aqueous granulation. Preferred production methods therefor include emulsifying or dispersing a solution or dispersion of toner materials including at least a colorant, a binder resin and a releasing agent in an aqueous medium and granulating toner particles (aqueous granulation). One preferred production method includes the following steps (1) to (6).

Step (1): Preparation of solution or dispersion of toner materials

The solution or dispersion of the toner materials is prepared by dissolving or dispersing a colorant, a binder resin, a releasing agent and other materials.

The toner material is not particularly limited, so long as it can form a toner, and can be appropriately selected depending on the purpose. For example, the toner material contains the polyester resin, the colorant and the releasing agent; and, if necessary, further contains a compound having an active hydrogen-containing group, a polyester capable of reacting with the compound having an active hydrogen-containing group (prepolymer), a charge controlling agent and other components. Note that the organic solvent is removed during or after granulation of toner particles.

The organic solvent is not particularly limited, so long as the toner material can be dissolved or dispersed in it, and can be appropriately selected depending on the purpose. For example, volatile organic solvents having a boiling point of lower than 150° C. are preferred since they can be easily removed. Examples thereof include toluene, xylene, benzene, tetrachloromethane, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone, with ester solvents being preferred, with ethyl acetate being particularly preferred. These may be used alone or in combination.

The amount of the organic solvent used is not particularly limited and can be appropriately determined depending on the purpose. For example, the amount thereof is preferably 40 parts by mass to 300 parts by mass, more preferably 60 parts by mass to 140 parts by mass, still more preferably 80 parts by mass to 120 parts by mass, per 100 parts by mass of the toner materials.

Notably, among the above toner materials, other components than a polymer capable of reacting with the compound having an active hydrogen-containing group (prepolymer) may be previously added to/mixed with an aqueous medium in below-described preparation of an aqueous dispersion; or may be added to an aqueous medium simultaneously with the solution or dispersion of toner materials.

Step (2): Preparation of aqueous medium

The aqueous medium is not particularly limited and can be appropriately selected from those known in the art. Examples thereof include water, water-miscible solvents and mixtures thereof. Among them, water is particularly preferred.

The water-miscible solvent is not particularly limited and examples thereof include alcohols, dimethylformamide, tetrahydrofuran, cellsolves and lower ketones.

Examples of the alcohol include methanol, isopropanol and ethylene glycol. Examples of the lower ketone include acetone and methyl ethyl ketone. These may be used alone or in combination.

An aqueous dispersion can be prepared by, for example, dispersing resin microparticles in the aqueous medium. The amount of the resin microparticles added to the aqueous medium is not particularly limited and can be appropriately determined depending on the purpose. Preferably, the amount thereof is 0.5% by mass to 10% by mass.

The resin microparticles are not particularly limited, as long as they can be dispersed in the aqueous medium to form an aqueous dispersion, and can be appropriately selected from those known in the art depending on the purpose. They may be a thermoplastic or thermosetting resin. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonate resins.

These may be used alone or in combination. Preferably, at least one selected from vinyl resins, polyurethane resins, epoxy resins and polyester resins is dispersed in the aqueous medium, from the viewpoint of easily preparing an aqueous dispersion containing spherical resin microparticles.

Notably, the vinyl resin is a homopolymer or copolymer of a vinyl monomer. Examples thereof include styrene-(meth)acrylate ester resins, styrene-butadiene copolymers, (meth)acrylic acid-acrylate ester polymers, styrene-acrylonitrile copolymers, styrene-maleic anhydride and styrene-(meth)acrylic acid copolymers.

As the resin microparticles, there can be used copolymers formed of a monomer having at least two unsaturated groups. The monomer having at least two unsaturated groups is not particularly limited and can be appropriately selected depending on the purpose. Exmaples thereof include a sodium salt of methacrylic acid ethylene oxide adduct sulfate (“Eleminol RS-30,” product of Sanyo Chemical Industries, Ltd.), divinyl benzene and 1,6-hexanediol acrylate.

The resin microparticles can be produced with a known polymerization method appropriately selected depending on the purpose. Preferably, an aqueous dispersion of the resin microparticles is produced. Preferred examples of methods for preparing the aqueous dispersion include the following methods (i) to (viii):

(i) a method in which an aqueous dispersion of resin maicroparticles (e.g., vinyl resin microparticles) is directly produced by subjecting a monomer (e.g., vinyl monomer) serving as a starting material to polymerization reaction with any one of the suspension polymerization method, the emulsification polymerization method, the seed polymerization method and the dispersion polymerization method;

(ii) a method in which an aqueous dispersion of microparticles of polyadded or condensed resins (e.g., polyester resins, polyurethane resins and epoxy resins) is produced by dispersing their precursor (e.g., monomer or oligomer) or a solution thereof in an aqueous medium in the presence of an appropriate dispersant and then curing the resultant dispersion with heating or through addition of a curing agent;

(iii) a method in which an aqueous dispersion of microparticles of polyadded or condensed resins (e.g., polyester resins, polyurethane resins and epoxy resins) is produced by dissolving an appropriate emulsifier in their precursor (e.g., monomer or oligomer) or a solution thereof (which is preferably a liquid or may be liquefied with heating) and then adding water the resultant mixture for phase inversion emulsification;

(iv) a method in which a resin is prepared through polymerization reaction (e.g., addition polymerization, ring-opening polymerization, polyaddition, addition condensation or condensation polymerization); the thus-prepared resin is pulverized using a mechanically rotary pulverizer, a jet pulverizer, etc., and then classified; and the thus-formed resin microparticels are dispersed in water in the presence of an appropriate dispersant;

(v) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is sprayed to produce resin microparticles; and the thus-produced resin microparticles are dispersed in water in the presence of an appropriate dispersant;

(vi) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution, followed by addition of a bad solvent for precipitation, or the thus-prepared resin is dissolved with heating in a solvent to prepare a resin solution, followed by cooling for precipitation; the solvent is removed to produce resin microparticles; and the thus-produced resin microparticles are dispersed in water in the presence of an appropriate dispersant;

(vii) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is dispersed in an aqueous medium in the presence of an appropriate dispersant; and the solvent is removed with heating or under reduced pressure; and

(viii) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; an appropriate emulsifier is dissolved in the thus-prepared resin solution; and water is added to the resultant solution for phase inversion emulsification.

Preferably, a dispersant is added to an aqueous medium in accordance with needs, from the viewpoints of forming stable oil droplets in the solution or dispersion during the below-described emulsification or dispersion and of forming resin microparticles having a desired shape and a sharp particle size distribution. The dispersant is not particularly limited and can be appropriately selected depending on the purpose. Examples thereof include surfactants, poorly water-soluble inorganic dispersants and polymeric protective colloids. These may be used alone or in combination. Among them, surfactants are preferably used.

Examples of the surfactant include anionic surfactants, cationic surfactants, nonionic surfactants and amphoteric surfactants.

Examples of the anionic surfactant include alkylbenzenesulfonic acid salts, α-olefin sulfonic acid salts and phosphoric acid esters. In particular, anionic surfactants having a fluoroalkyl group are preferred.

Examples thereof include fluoroalkyl carboxylic acids having 2 to 10 carbon atoms and metal salts thereof, disodium perfluorooctanesulfonylglutamate, sodium 3-[omega-fluoroalkyl(C6 to C11)oxy)-1-alkyl(C3 or C4) sulfonates, sodium 3-[omega-fluoroalkanoyl(C6 to C8)-N-ethylamino]-1-propanesulfonates, fluoroalkyl(C11 to C20) carboxylic acids and metal salts thereof, perfluoroalkylcarboxylic acids(C7 to C13) and metal salts thereof, perfluoroalkyl(C4 to C12)sulfonates and metal salts thereof, perfluorooctanesulfonic acid diethanol amide, N-propyl-N-(2-hydroxyethyl)perfluorooctanesulfone amide, perfluoroalkyl(C6 to C10)sulfoneamidepropyltrimethylammonium salts, salts of perfluoroalkyl(C6 to C10)-N-ethylsulfonylglycin and monoperfluoroalkyl(C6 to C16) ethylphosphates.

Examples of commercially available products of the above-listed fluoroalkyl group-containing anionic surfactants include SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of Dainippon Ink and Chemicals, Inc.); ECTOP EF-102, 103, 104, 105, 112, 123A, 123B, 306A, 501, 201 and 204 (these products are of Tohchem Products Co., Ltd.); and FUTARGENT F-100 and F150 (these products are of NEOS COMPANY LIMITED).

Examples of the cationic surfactant include amine salts and quaternary ammonium salts.

Examples of the amine salt include alkyl amine salts, aminoalcohol fatty acid derivatives, polyamine fatty acid derivatives and imidazoline.

Examples of the quaternary ammonium salt include alkyltrimethylammonium salts, dialkyl dimethylammonium salts, alkyl dimethyl benzyl ammonium salts, pyridinium salts, alkyl isoquinolinium salts and benzethonium chloride.

Further examples of the cationic surfactant include fluoroalkyl group-containing aliphatic primary/secondary/tertiary amine acids, aliphatic quaternary ammonium salts (e.g., perfluoroalkyl(C6 to C10)sulfoneamide propyltrimethylammonium salts), benzalkonium salts, benzetonium chloride, pyridinium salts and imidazolinium salts.

Examples of commercially available products of the above-listed cationic surfactants include SURFLON S-121 (product of Asahi Glass Co., Ltd.); FRORARD FC-135 (product of Sumitomo 3M Ltd.); UNIDYNE DS-202 (product of Daikin Industries, Ltd.); MEGAFACE F-150 and F-824 (these products are of Dainippon Ink and Chemicals, Inc.); ECTOP EF-132 (product of Tohchem Products Co., Ltd.); and FUTARGENT F-300 (product of Neos COMPANY LIMITED).

Examples of the nonionic surfactant include fatty acid amide derivatives and polyhydric alcohol derivatives.

Examples of the amphoteric surfactant include alanine, dodecyl-di(aminoethyl)-glycine, di(octylaminoethyl)-glycine and N-alkyl-N,N-dimethylammonium betaine.

Examples of the poorly water-soluble inorganic dispersant include tricalcium phosphate, calcium carbonate, titanium oxide, colloidal silica and hydroxyapatite.

Examples of the polymeric protective colloid include homopolymers or copolymers of acids; homopolymers or copolymers of hydroxyl group-containing (meth)acrylic monomers; homopolymers or copolymers of vinyl alcohol or ethers thereof; homopolymers or copolymers of esters formed between vinyl alcohol and a carboxyl group-containing compound; homopolymers or copolymers of amide compounds or methylol compounds thereof; homopolymers or copolymers of chlorides; homopolymers or copolymers of nitrogen atom-containing compounds; and homopolymers or copolymers of compounds having a nitrogen atom-containing heterocyclic group. Further examples thereof include polyoxyethylenes and celluloses.

Examples of the acid include acrylic acid, methacrylic acid, α-cyanoacrylic acid, α-cyanomethacrylic acid, itaconic acid, crotonic acid, fumaric acid, maleic acid and maleic anhydride.

Examples of the hydroxyl group-containing (meth)acrylic monomer include β-hydroxyethyl acrylate, β-hydroxyethyl methacrylate, β-hydroxypropyl acrylate, β-hydroxypropyl methacrylate, γ-hydroxypropyl acrylate, Zγ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide.

Examples of the vinyl alcohol and ethers thereof include vinyl methyl ether, vinyl ethyl ether and vinyl propyl ether.

Examples of the esters formed between vinyl alcohol and a carboxyl group-containing compound include vinyl acetate, vinyl propionate and vinyl butyrate.

Examples of the amide compounds and methylol compounds thereof include acrylamide, methacrylamide, diacetone acrylamide, and methylol compounds of these amide compounds. Examples of the chlorides include acrylic acid chloride and methacrylic acid chloride.

Examples of the nitrogen atom-containing compounds and compounds having nitrogen atom-containing heterocyclic group include vinyl pyridine, vinyl pyrrolidone, vinyl imidazole and ethyleneimine.

Examples of the polyoxyethylenes include polyoxyethylenes, polyoxypropylenes, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters.

Examples of the cellulose include methyl cellulose, hydroxyethyl cellulose and hydroxypropyl cellulose.

If necessary, a dispersion stabilizer may be used for preparing the dispersion.

Examples of the dispersion stabilizer include acids (e.g., calcium phosphate) and alkali-soluble compounds.

When the solution or dispersion contains, as a binder resin, a modified polyester capable of reacting with a compound having an active hydrogen-containing group (prepolymer), dibutyltin laurate, dioctyltin laurate, etc. may be added to the aqueous medium to catalyze reaction between the prepolymer and the compound having an active hydrogen-containing group.

Step (3): Emulsification or dispersion

In emulsifying or dispersing the solution or dispersion containing the toner materials in the aqueous medium, the solution or dispersion is preferably dispersed therein under stirring. The disperser used in this dispersion is not particularly limited. Examples thereof include batch-type emulsifiers such as Homogenizer (product of IKA Co.), Polytron (product of KINEMATICA Co.) and TK Auto Homomixer (product of Tokushu Kika Kogyo Co.); continuous-type emulsifiers such as Ebara Milder (product of Ebara Corporation), TK Filmics and TK Pipeline Homomixer (these products are of Tokushu Kika Kogyo Co.), Colloid Mill (product of Shinko Pantec Co., Ltd.), Slusher and Trigonal Wet Mill (these products are of Mitsui Miike Kakoki K.K.), Cavitron (product of EUROTEC Ltd.) and Fine Flow Mill (product of Pacific Machinery & Engineering Co., Ltd.); high-pressure emulsifiers such as Microfluidizer (product of Mizuho Industrial Co., Ltd.), Nanomizer (product of Nanomizer Inc.) and APV Gaulin (product of Gaulin Inc.); membrane emulsifiers such as Membrane Emulsifier (product of REICA Co., Ltd.); vibration-type emulsifiers such as Vibromixer (product of REICA CO., Ltd.); and ultrasonic emulsifiers such as Ultrasonic Homogenizer (product of BRANSON Co.). Among them, from the viewpoint of forming particles having a uniform particle size, APV Gaulin, Homogenizer, TK Auto Homomixer, Ebara Milder, TK Filmics and TK Pipeline Homomixer are preferably used.

Notably, when the solution or dispersion contains, as a binder resin, a modified polyester capable of reacting with a compound having an active hydrogen-containing group (prepolymer), reaction between the prepolymer and the compound proceeds during emulsification or dispersion. The reaction conditions are not particularly limited and can be appropriately determined in consideration of a selected compound having an active hydrogen-containing group and a selected polymer capable of reacting with the compound having an active hydrogen-containing group. The reaction time is preferably 10 min to 40 hours, more preferably 2 hours to 24 hours.

Step (4): Removal of solvent

In this step, the organic solvent is removed from the emulsified slurry which has been produced through the above emulsification or dispersion. For example, removal of the organic solvent is performed as follows: (1) the entire reaction system is gradually increased in temperature to completely evaporate the organic solvent contained in oil droplets; or (2) the emulsified dispersion is sprayed in a dry atmosphere to completely remove/evaporate the water insoluble organic solvent contained in oil droplets together with the aqueous dispersant, whereby toner particles are formed.

Step (5): Washing, drying, classification, etc.

In Step (4), the organic solvent is removed to form toner particles. The thus-formed toner particles may be subjected to washing, drying, etc., and then, if necessary, to classification, etc.

Classification may be performed by removing very fine particles using a cyclone, a decanter, a centrifugal separator, etc. in the liquid. Alternatively, after drying, the formed powdery toner particles may be classified. When an acid/alkali-dissolvable compound (e.g., calcium phosphate) is used as a dispersion stabilizer in the aqueous medium, for example, an acid (e.g., hydrochloric acid) is added to the aqueous medium to dissolve the dispersion stabilizer, followed by washing with water to remove it from toner particles.

Step (6): External addition of charge controlling agent, releasing agent, etc.

If necessary, the toner particles produced through the above-described steps may be mixed with, for example, a releasing agent and a charge controlling agent; i.e., inorganic microparticles such as silica microparticles and titanium oxide microparticles. Furthermore, a mechanical impact may be applied to the resultant mixture (toner particles) for preventing the releasing agent, etc. from dropping off the surface of the toner particles.

Examples of the method for applying a mechanical impact to a mixture (toner particles) include a method in which an impact is applied to a mixture using a high-speed rotating blade; and a method in which a mixture is caused to pass through a high-speed airflow to form aggregated particles, followed by crushing against an appropriate collision plate. Examples of apparatuses used in these methods include Ongmill (product of Hosokawa Micron Corp.), an apparatus produced by modifying an I-type mill (product of Nippon Neumatic Co., Ltd.) so that the pulverizing air pressure thereof is decreased, Hybridization System (product of Nara Machinery Co., Ltd.), Cryptron System (production of Kawasaki Heavy Industries, Ltd.) and an automatic mortar.

### [Physical Properties of Toner]

The shape, size, etc. of the toner is not particularly limited and can be appropriately determined depending on the purpose. Preferably, the toner has an average circularity, volume average particle diameter, ratio of volume average particle diameter to number average particle diameter (volume average particle diameter/number average particle diameter) etc. as described below.

The average circularity is a value obtained as follows: a circle having the same area as the project area of the toner particles is obtained; and the circumference of the circle is divided by that of the toner particles. For example, it is preferably 0.900 to 0.980, more preferably 0.950 to 0.975. Also, in the toner, the amount of particles having an average circularity less than 0.94 is preferably 15% or lower.

The toner having an average circularity less than 0.900 cannot exhibit satisfactorily transferability and provide high-quality images with no toner dusts. Meanwhile, the toner having an average circularity more than 0.980 is not sufficiently removed from, for example, a photoconductor and a transfer belt provided in an image forming apparatus employing a cleaning blade, and such cleaning failure causes smear on the image formed. For example, when toner is not transferred due to, for example, paper-feed failure during formation of an image having a high image area ratio (e.g., photographic image), the toner remains and is accumulated on the photoconductor surface, causing color smear and/or staining, for example, a charging roller used for contact-charging the photoconductor. As a result, the charging roller may not exhibit intrinsic charging ability.

The average circularity can be measured as follows: a toner sample is subjected to measurement using the flow-type particle image analyzer FPIA-2100 (product of Sysmex Co.) and then the obtained measurements are analyzed using the analysis software FPIA-2100 Data Processing Program for FPIA version 00-10. Specifically, a 10% by mass surfactant (alkylbenzene sulfonate, Neogen SC-A, product of Daiichi Kogyo Seiyaku Co.) (0.1 mL to 0.5 mL) is added to a 100 mL-glass beaker, and a toner sample (0.1 g to 0.5 g) is added thereto, followed by stirring with a microspartel. Subsequently, ion-exchange water (80 mL) is added to the beaker, and the obtained dispersion is dispersed with an ultrasonic wave disperser (product of Honda Electronics Co.) for 3 min. The resultant dispersion is measured with respect to the shape/distribution of toner using the FPIA-2100 until the toner density falls within a range of 5,000/μL to 15,000/μL.

Notably, in this method, it is important that the toner density of the dispersion is adjusted to 5,000/μL to 15,000/μL, considering attaining desired measurement reproducibility with respect to the average circularity. In order for the toner density to fall within the above range, the conditions under which the dispersion is prepared must be modified; i.e., the amounts of a surfactant and toner added must be adjusted.

The amount of the surfactant required varies depending on the hydrophobicity of the toner. Specifically, when it is added in a large amount, bubbles generated cause a noise; whereas when it is added in a small amount, the toner surface cannot be provided with sufficient wettability and thus a sufficient dispersion state cannot be attained. Meanwhile, the amount of the toner added varies depending on the particle diameter thereof. Specifically, the toner with a small particle diameter must be added in a small amount, and the toner with a large particle diameter must be added in a large amount. For example, when the toner with a particle diameter of 3 μm to 10 μm is added in an amount of 0.1 g to 0.5 g, the toner density of the formed dispersion can be adjusted to 5,000/μL to 15,000/μL.

The volume average particle diameter of the toner can be appropriately determined depending on the purpose and is preferably 3 μm to 10 μm, more preferably 3 μm to 8 μm.

When used in a two-component developer, a toner having a volume average particle diameter smaller than 3 μm is fused on the surface of a carrier after long-term stirring in a developing device, potentially reducing the charging ability of the carrier. Meanwhile, a toner having a volume average particle diameter larger than 10 μm cannot provide a high-resolution, high-quality image in some cases, and may exhibit large variation in its particle diameter after repetitive cycles of consumption and addition thereof in the developer.

The ratio of volume average particle diameter to number average particle diameter of the toner (volume average particle diameter/number average particle diameter) is preferably 1.00 to 1.25, more preferably 1.00 to 1.16 (1.10 to 1.25).

The volume average particle diameter and the ratio of volume average particle diameter to number average particle diameter (volume average particle diameter/number average particle diameter) can be obtained as follows: a toner sample is subjected to measurement using a particle size analyzer (Multisizer III, product of Beckman Coulter Co.) with the aperture diameter being set to 100 μm, and the obtained measurements are analyzed with analysis software (Beckman Coulter Multisizer 3 Version 3.51.).

Specifically, a 10% by mass surfactant (alkylbenzene sulfonate, Neogen SC-A, product of Daiichi Kogyo Seiyaku Co.) (0.5 mL) is added to a 100 mL-glass beaker, and a toner sample (0.5 g) is added thereto, followed by stirring with a microspartel. Subsequently, ion-exchange water (80 mL) is added to the beaker, and the obtained dispersion is dispersed with an ultrasonic wave disperser (W-113MK-II, product of Honda Electronics Co.) for 10 min. The resultant dispersion is measured using the above Multisizer III and Isoton III (product of Beckman Coulter Co.) serving as a solution for measurement.

The color of the toner is not particularly limited and can be appropriately selected depending on the purpose, and at least one selected from black toner, cyan toner, magenta toner and yellow toner can be used. Each color toner can be prepared using a corresponding colorant appropriately selected from the above-listed colorants.

Preferably, color toners are used.

An image forming method of the present invention is characterized by including at least a latent electrostatic image forming step for forming a latent electrostatic image on a latent electrostatic image bearing member, a developing step for developing the latent electrostatic image using the two-component developer of the present invention (hereinafter abbreviated as a “developer”) to form a visible image, a transferring step for transferring the visible image onto the recording medium, and a fixing step for fixing the transferred image on the recording medium. Next will be exemplarily described a developer accommodating container, a process cartridge, an image forming apparatus, etc. which are used for performing the image forming method of the present invention.

### <Developer>

The developer of the present invention is a two-component developer containing the above-described carrier of the present invention and the above-described toner.

In this developer, the mixing ratio of toner to carrier is preferably 1.0 part by mass/100 parts by mass to 10.0 parts by mass/100 parts by mass.

### <Developer Accommodating Container>

The developer accommodating container consists of a container and the developer of the present invention accommodated in the container. The container is not particularly limited and can be appropriately selected from known containers. For example, preferred are those having a cap and a container main body for accommodating a developer. The size, shape, structure and material of the container main body are not particularly limited and can be appropriately determined depending on the purpose.

The container main body preferably has, for example, a hollow-cylindrical shape. Particularly preferably, it is a hollow-cylindrical body whose inner surface has spirally-arranged concavo-convex portions some or all of which can accordion and in which a developer accommodated can be transferred to an outlet port through rotation.

The material for forming the container main body is not particularly limited and is preferably materials from which the container main body can be formed with high dimensional accuracy. Preferred examples thereof include resins. Among them, preferred are polyester resins, polyethylene resin, polypropylene resins, polystyrene resins, polyvinyl chlorides resins, polyacrylic acids, polycarbonate resins, ABS resins, polyacetal resins, etc.

This developer accommodating container has excellent handleability; i.e., is suitable for storage, transportation, etc. and is suitably used for supply of the developer with being detachably mounted to the below-described process cartridge, image forming apparatus, etc.

### <Process Cartridge>

A process cartridge used in the present invention includes at least a latent electrostatic image bearing member for bearing a latent electrostatic image, a developing unit configured to develop the latent electrostatic image formed on the latent electrostatic image bearing member using a developer to form a visible image; and, if necessary, further includes appropriately selected other units.

The developing unit includes at least a developer accommodating container accommodating the developer of the present invention, and a developer-carrier for bearing and carrying the developer accommodated in the developer accommodating container; and, if necessary, further includes a layer-thickness controlling member for controlling the thickness of toner carried on the developer-carrier.

The process cartridge may be detachably mounted to various electrographic image forming apparatuses. Preferably, it is detachably mounted to an image forming apparatus of the present invention described below.

As shown in FIG. 2, the process cartridge includes a built-in photoconductor 101, a charging unit 102, an exposing unit, a developing unit 104, a transferring unit 108 and a cleaning unit 107; and, if necessary, further includes other units. In FIG. 2, reference numeral 103 refers to light applied from the exposing unit, which employs a light source capable of writing at high resolution. Note that reference numeral 105 refers to a recording medium. The photoconductor 101 may be the same photoconductors as used in an image forming apparatus described below. The charging unit 102 may be an optionally selected charging member.

Next will be described an image forming process by the process cartridge shown in FIG. 2. While rotated in a direction indicated by an arrow, the photoconductor 101 is charged by the charging unit 102 and then imagewise exposed to light 103 from the exposing unit (not illustrated) to have, on its surface, a latent electrostatic image corresponding to the light. The latent electrostatic image is developed with the two-component developer of the present invention by the developing unit 104. The developed toner image is transferred onto the recording medium 105 by the transfer unit 108, and then the recording medium 105 is output. The photoconductor surface after transfer of the toner image is cleaned by the cleaning unit 107 and then charge-eliminated by a charge-eliminating unit (not illustrated). The above-described cycle is repeatedly performed.

### <Image Forming Method and Image Forming Apparatus>

As described above, the image forming method of the present invention includes at least a latent electrostatic image forming step, a developing step, a transferring step and a fixing step; and, if necessary, further includes appropriately selected other steps such as a charge-eliminating step, a cleaning step, a recycling step and a controlling step.

An image forming apparatus used in the image forming method of the present invention includes at least a latent electrostatic image bearing member, a latent electrostatic forming unit, a developing unit, a transfer unit and a fixing unit; and, if necessary, further includes appropriately selected other steps such as a charge-eliminating unit, a cleaning unit, a recycling unit and a controlling unit.

### <<Latent Electrostatic Image Forming Step, Charging Unit, and Exposing Unit>>

The latent electrostatic image forming step is a step of forming a latent electrostatic image on a latent electrostatic image bearing member.

In the latent electrostatic image bearing member (hereinafter may be referred to as an “electrophotographic photoconductor” or a “photoconductor”), its material, shape, structure, size, etc. are not particularly limited and can be appropriately selected from those known in the art. The latent electrostatic image bearing member preferably has a drum shape and may be made of, for example, inorganic photoconductor materials (e.g., amorphous silicon and serene) and organic photoconductor (OPC) materials (e.g., polysilane and phthalopolymethine). Among them, amorphous silicon, etc. are preferably used in terms of attaining a long service life.

The latent electrostatic image can be formed by the latent electrostatic image forming unit, for example, as follows: a surface of the latent electrostatic image bearing member is uniformly charged and then imagewise exposed. The latent electrostatic image forming unit includes at least a charging device for uniformly charging the surface of the latent electrostatic image bearing member, and an exposing device for imagewise exposing the surface of the latent electrostatic image bearing member.

Charging can be performed by, for example, applying a voltage onto a surface of the latent electrostatic image bearing member using a charging device.

The charging device is not particularly limited and can be appropriately selected depending on the purpose. Examples thereof include contact charging devices known per se having a conductive or semi-conductive roller, brush, film, or rubber blade, and non-contact charging devices employing corona discharge (e.g., a corotron and a scorotron).

The charging device is preferably those applying both DC and AC voltages onto the latent electrostatic image bearing member with being disposed so as to be in contact or non-contact therewith.

Also, the charging device is preferably a charging roller charging the latent electrostatic image bearing member through application of both DC and AC voltages with being disposed proximately thereto via a gap tape; i.e., in a non-contact manner.

Exposure can be performed by, for example, imagewise exposing a surface of the latent electrostatic image bearing member using an exposing device. The exposing device is not particularly limited, so long as an imagewise exposed image of interest can be formed on the latent electrostatic image bearing member surface which has been charged by the charging device, and can be appropriately selected depending on the purpose. Examples thereof include various exposing devices such as copy optical systems, rod lens array systems, laser optical systems and liquid crystal shutter optical systems. Notably, in the present invention, exposure may be performed by imagewise exposing the latent electrostatic image bearing member from the backside thereof.

### <<Developing Step and Developing Unit>>

The developing step is a step of developing the latent electrostatic image using the developer of the present invention to form a visible image.

The visible image can be formed with the aforementioned developing unit by, for example, developing the latent electrostatic image using the developer of the present invention.

The developing unit is not particularly limited, so long as development can be performed using, for example, the developer of the present invention, and can be appropriately selected depending on the purpose. Preferred examples thereof include those having at least a developing device which accommodates the developer of the present invention and can apply the developer to the latent electrostatic image in a contact or non-contact manner. More preferred examples thereof include developing devices having the above-described developer accommodating container.

The developing device may employ a dry or wet developing method, or may be a monochromatic or multicolor developing device. Preferred examples thereof include those having a stirrer frictionally charging the developer and a ratatable magnetic roller.

In the developing device, the above toner and carrier are stirred so that the toner is charged by friction generated therebetween. The charged toner is retained in the chain-like form on the surface of the rotating magnetic roller to form a magnetic brush. The magnetic roller is disposed in the vicinity of the latent electrostatic image bearing member (photoconductor) and thus, some of the toner forming the magnetic brush are electrically adsorbed onto a surface of the latent electrostatic image bearing member (photoconductor). As a result, the electrostatic latent image is developed with the toner to form a visible toner image on the surface of the latent electrostatic image bearing member (photoconductor).

The developing device accommodates the developer of the present invention.

### <<Transferring Step and Transfer Unit>>

The transferring step is a step of transferring the visible image onto a recording medium. In this step, preferably, visible images are primarily transferred onto an intermediate transfer member, and the thus-transferred visible images are secondarily transferred onto the recording medium. Also, toners of two or more colors are used (a full color toner is preferably used). More preferably, the transferring step includes a primarily-transferring step for transferring the visible images onto an intermediate member to form a composite transfer image; and a secondarily-transferring step for transferring the composite transfer image onto a recording medium.

For example, the visible image can be transferred in the transfer unit by charging the latent electrostatic image bearing member (photoconductor) with a transfer charger. Preferably, the transfer unit includes a primarily-transfer unit for transferring visible images onto an intermediate member to form a composite transfer image; and a secondarily-transfer unit for transferring the composite transfer image onto a recording medium.

The intermediate transfer member is not particularly limited and can be appropriately selected from known transfer members depending on the purpose. Preferred examples of the intermediate transfer member include a transfer belt.

The transfer unit (consisting of the primarily- and secondarily-transfer units) preferably includes a transfer device which transfers visible images from a latent electrostatic image bearing member (photoconductor) onto a recording medium. The image forming apparatus may include at least one transferring unit.

Examples of the transfer device include a corona transferring device employing corona discharge, a transfer belt, a transfer roller, a pressing transfer roller and an adhesive transferring device.

The recording medium is not particularly limited and can be appropriately selected from known recording media (recording paper) depending on the purpose.

### <<Fixing Step and Fixing Unit>>

The fixing step is a step of fixing, with a fixing device, the visible image which has been transferred onto the recording medium. The fixing step may be performed every after an image formed by the developer of each color is transferred onto the recording medium; or may be performed at one time after images formed by the developers of all colors are superposed on the recording medium.

The fixing device is not particularly limited and can be appropriately selected depending on the purpose. A known heat-pressing device is preferably used. Examples of the heat-pressing device include a combination of a heating roller and a pressing roller; and a combination of a heating roller, a pressing roller and an endless belt.

Preferably, the fixing device is a unit configured to have a heating body equipped with a heat generator, a film being in contact with the heating body, and a pressing member which is pressed via the film against the heating body at appropriate timing; and to heat-fix an unfixed image formed on the recording medium between the film and the heating body. Generally, the heating temperature in the heating-pressing unit is preferably at 80° C. to 200° C.

In the fixing step in the present invention, a known photo-fixing device, etc. is used together with or instead of the fixing unit (step) depending on the purpose.

### <<Charge-Eliminating Step and Charge-Eliminating Unit>>

The charge-eliminating step is a step of eliminating charges by applying a charge-eliminating bias to the latent electrostatic image bearing member, and can be preferably performed by the charge-eliminating unit.

The charge-eliminating unit is not particularly limited, so long as it can apply a charge-eliminating bias to the latent electrostatic image bearing member, and can be appropriately selected from known charge-eliminating devices. Preferably, a charge-eliminating lamp, etc. are used.

### <<Cleaning Step and Cleaning Unit>>

The cleaning step is a step of removing the toner remaining on the latent electrostatic image bearing member, and is preferably performed by a cleaning unit.

The cleaning unit is not particularly limited, so long as it can remove the toner remaining on the latent electrostatic image bearing member, and can be appropriately selected from known cleaners.

Preferred examples thereof include a magnetic blush cleaner, an electrostatic brush cleaner, a magnetic roller cleaner, a blade cleaner, a brush cleaner and a web cleaner.

### <<Recycling Step and Recycling Unit>>

The recycling step is a step of recycling the toner removed in the above cleaning step to the developing unit, and can be preferably performed by the recycling unit. The recycling unit is not particularly limited and may be, for example, a known conveying unit.

### <<Controlling Step and Controlling Unit>>

The controlling step is a step of controlling each of the above steps, and can be preferably performed by the controlling unit. The controlling unit is not particularly limited, so long as it can control the operation of unit, and may be appropriately selected depending on the purpose. Examples thereof include devices such as sequencers and computers.

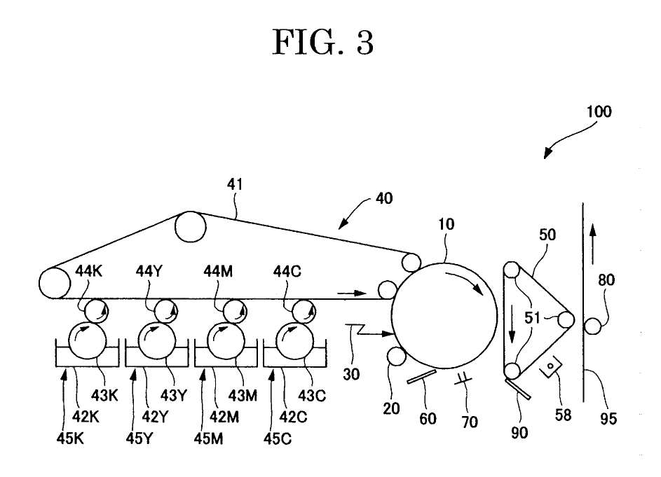

With reference to FIG. 3, next will be described an embodiment of the image forming method of the present invention employing the image forming apparatus. An image forming apparatus 100 shown in FIG. 3 includes a photoconductor drum 10 (photoconductor 10) serving as the latent electrostatic image bearing member, a charging roller 20 serving as the charging unit, an exposing device 30 serving as the exposing unit, a developing device 40 serving as the developing unit, an intermediate transfer member 50, a cleaning device 60 serving as the cleaning unit, and a charge-eliminating lamp 70 serving as the charge-eliminating unit.

The intermediate transfer member 50 is an endless belt and can be driven in a direction indicated by an arrow with three supporting rollers 51 which are provided in a loop of the belt. Some of three rollers 51 serve also as a transfer bias roller capable of applying a predetermined transfer bias (primary transfer bias) to the intermediate transferring member 50. A cleaning blade 90 for cleaning the intermediate transfer member is disposed in the vicinity of the intermediate transfer member 50. Also, a transfer roller 80 is disposed so as to face the intermediate transfer member 50 and serves as a transfer unit capable of applying a transfer bias for transferring (secondarily transferring) a visible image (toner image) onto a recording medium 95. Around the intermediate transfer member 50, a corona charger 58 for applying charges to the visible image on the intermediate transfer member 50 is disposed between the cleaning blade 90 and a contact portion of the intermediate transfer member 50 with the recording medium 95.

The developing device 40 includes a developing belt 41 serving as the developer-carrier; and a black developing unit 45K, a yellow developing unit 45Y, a magenta developing unit 45M and a cyan developing unit 45C, these units being arranged in a row around the developing belt 41. The black developing unit 45K includes a developer accommodating section 42K, a developer supplying roller 43K, and a developing roller 44K. The yellow developing unit 45Y includes a developer accommodating section 42Y, a developer supplying roller 43Y, and a developing roller 44Y. The magenta developing unit 45M includes a developer accommodating section 42M, a developer supplying roller 43M, and a developing roller 44M. The cyan developing unit 45C includes a developer accommodating section 42C, a developer supplying roller 43C, and a developing roller 44C. The developing belt 41 is an endless belt and is rotatably supported by a plurality of belt rollers, some of which are in contact with the latent electrostatic image bearing member 10.

In the image forming apparatus 100 shown in FIG. 3, for example, the charging roller 20 uniformly charges the photoconductor drum 10. The photoconductor drum 10 is imagewise exposed by the exposing device 30 to form a latent electrostatic image. The latent electrostatic image formed on the photoconductor drum 10 is developed with a toner supplied from the developing device 40 to form a visible image (toner image). The visible image (toner image) is transferred onto the intermediate transferring member 50 (primary transfer) with a voltage applied from the rollers 51. The thus-transferred image is transferred onto the recording paper 95 (secondary transfer). As a result, the transfer image is formed on the recording paper 95. Notably, toner particles remaining on the photoconductor 10 are removed by the cleaning device 60, and charges on the photoconductor 10 are removed by the charge-eliminating lamp 70.

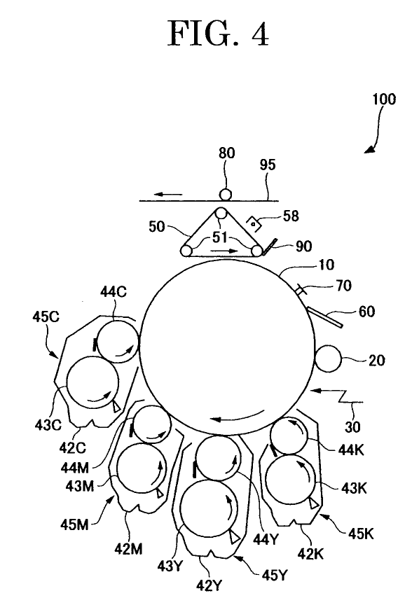

With reference to FIG. 4, next will be described another embodiment of the image forming method of the present invention employing the image forming apparatus.

An image forming apparatus 100 shown in FIG. 4 has the same configuration as the image forming apparatus 100 shown in FIG. 3, except that no developing belt 41 is provided and a black developing unit 45K, a yellow developing unit 45Y, a magenta developing unit 45M, and a cyan developing unit 45C are disposed around the photoconductor 10 so as to directly face it. Also, the image forming apparatus 100 shown in FIG. 4 exhibits the same effects as the image forming apparatus 100 shown in FIG. 3. Note that common members to both in FIGS. 3 and 4 are indicated by the same reference numerals.

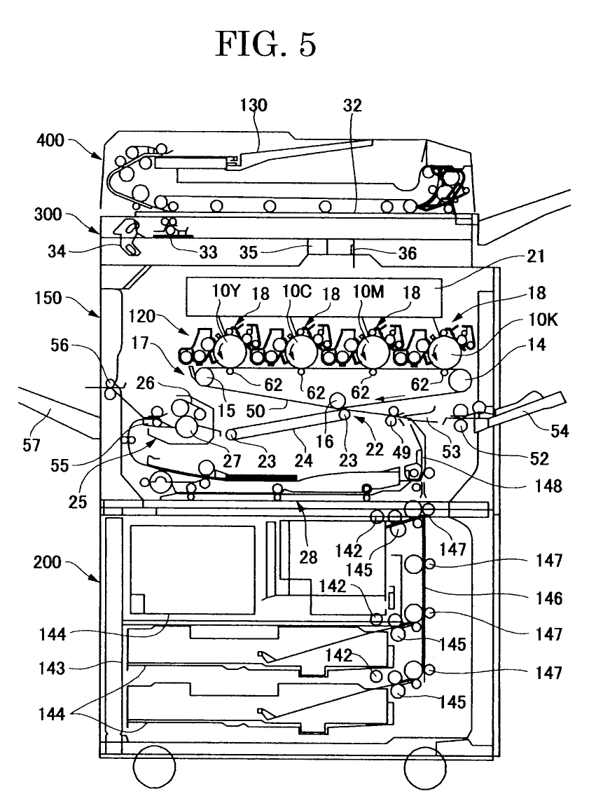

With reference to FIG. 5, next will be described still another embodiment of the image forming method of the present invention employing the image forming apparatus. An image forming apparatus shown in FIG. 5 is a tandem color image forming apparatus. This image forming apparatus includes a copying device main body 150, a paper feeding table 200, a scanner 300 and an automatic document feeder (ADF) 400.

The copying device main body 150 is provided at its center portion with an endless belt-shaped intermediate transferring member 50. In FIG. 5, the intermediate transfer member 50 can be clockwise rotated by supporting rollers 14, 15 and 16. A cleaning device 17 for removing toner particles remaining on the intermediate transfer member 50 is disposed in the vicinity of the supporting roller 15. Around the intermediate transfer member 50 tightly stretched by supporting rollers 14 and 15 is provided a tandem developing device 120 in which four image forming units 18 for yellow toner, cyan toner, magenta toner and black toner are arranged in a row along a moving direction of the intermediate transfer member. An exposing device 21 is provided in the vicinity of the tandem developing device 120. A secondary transfer device 22 is provided on the intermediate transfer member 50 on the side opposite to the side where the tandem developing device 120 is disposed. The secondary transfer device 22 includes an endless belt-shaped secondary transfer belt 24 and a pair of supporting rollers 23 tightly stretching the belt. A recording paper fed on the secondary transfer belt 24 can come into contact with the intermediate transfer member 50. A fixing device 25 is provided in the vicinity of the secondary transfer device 22. The fixing device 25 includes an endless fixing belt 26 and a press roller 27 provided so as to be pressed against the fixing belt.

Notably, in the tandem image forming apparatus, a sheet reversing device 28 for reversing the recording paper when image formation is performed on both sides of the recording paper is disposed in the vicinity of the secondary transfer device 22 and the fixing device 25.

Next will be described formation of a full color image (color copy) using the tandem developing device 120.

Firstly, an original document is set on a document table 130 of the automatic document feeder (ADF) 400. Alternatively, the automatic document feeder 400 is opened and then an original document is set on a contact glass 32 of the scanner 300, followed by closing of the automatic document feeder 400.

In the former case, when a starting switch (not illustrated) is pressed, the scanner 300 is operated to run a first carriage 33 and a second carriage 34 after the original document has been transferred onto the contact glass 32. In the latter case, when a starting switch (not illustrated) is pressed, the scanner 300 is operated to run a first carriage 33 and a second carriage 34 immediately after the original document has been set on the contact glass 32. At that time, the first carriage 33 irradiates the original document with light from a source, and then the second carriage 34 reflects, on its mirror, light reflected by the original document. The thus-reflected light is received by a reading sensor 36 through an imaging lens 35 for reading the original document (color image), to thereby form image information corresponding to black, yellow, magenta and cyan.

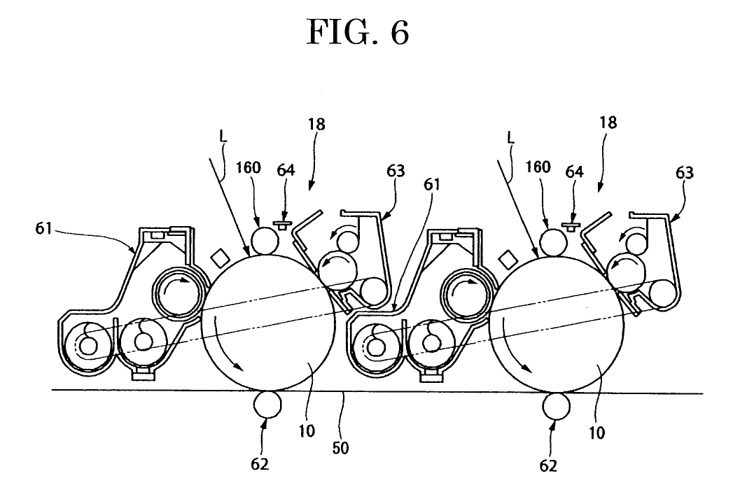

The thus-formed image information corresponding to black, yellow, magenta and cyan is transferred to a corresponding image forming unit 18 (black-, yellow-, magenta- or cyan-image forming unit) in the tandem developing device 120, and then a toner image of each of black, yellow, magenta and cyan is formed with the image forming unit. Specifically, as shown in FIG. 6—a partially enlarged view of the image forming apparatus shown in FIG. 5—, each of the image forming units 18 (black-, yellow-, magenta- and cyan-image forming units) in the tandem developing device 120 includes a latent electrostatic image bearing member 10 (black-latent electrostatic image bearing member 10K, yellow-latent electrostatic image bearing member 10Y, magenta-latent electrostatic image bearing member 10M or cyan-latent electrostatic image bearing member 10C); a charger 160 for uniformly charging the latent electrostatic image bearing member 10; an exposing device for imagewise exposing the latent electrostatic image bearing member to light (indicated by a symbol L in FIG. 6) based on image information corresponding to black, yellow, magenta and cyan to form thereon a latent electrostatic image corresponding to each of black, yellow, magenta and cyan; a developing device 61 for developing the latent electrostatic image with each color toner (black toner, yellow toner, magenta toner and cyan toner) to form a color toner image; a transfer charger 62 for transferring the color toner image onto the intermediate transfer member 50; a cleaning device 63; and a charge-eliminating device 64. With this configuration, each monochromatic image (black, yellow, magenta or cyan image) can be formed based on image information corresponding to each color. The thus-formed black, yellow, magenta and cyan images—a black image formed on the black-latent electrostatic image bearing member 10K, a yellow image formed on the yellow-latent electrostatic image bearing member 10Y, a magenta image formed on the magenta-latent electrostatic image bearing member 10M, and a cyan image formed on the cyan-latent electrostatic image bearing member 10C—are sequentially transferred (primarily transferred) onto the intermediate transfer member 50 driven by the supporting rollers 14, 15 and 16 shown in FIG. 5 so as to be rotated. Then, the black, yellow, magenta and cyan images are superposed on the intermediate transfer member 50 to form a composite color image (transferred color image).

In the paper feeding table 200, one of paper feeding rollers 142 is selectively rotated to feed sheets (recording paper) from one of vertically stacked paper feeding cassettes 144 housed in a paper bank 143. The thus-fed sheets are separated one another by a separating roller 145. The thus-separated sheet is fed through a paper feeding path 146, then fed through a paper feeding path 148 in a copying device main body 150 by a transfer roller 147, and stopped at a resist roller 49. Alternatively, paper feeding rollers 142 are rotated to feed sheets (recording paper) placed on a manual-feeding tray 54. The thus-fed sheets are separated one another by a separating roller 52. The thus-separated sheet is fed through a manual paper-feeding path 53 and then stopped at a resist roller 49 similar to the above.

Notably, the resist roller 49 is generally connected to the ground in use. Alternatively, it may be used with being applied by a bias for removing paper dust from the sheet. The resist roller 49 is rotated to feed a sheet (recording paper) between the intermediate transfer member 50 and the secondary transfer device 22 so that the composite color image (transferred color image) formed on the intermediate transfer member 50 is transferred (secondarily transferred) onto the sheet (recording paper), whereby a color image is formed on the sheet (recording paper). Notably, toner particles remaining on the intermediate transfer member 50 after image transfer is removed by a cleaning device 17 for cleaning the intermediate transfer member.

The sheet (recording paper) having a color image is fed by the secondary transfer device 22 to a fixing device 25. The fixing device 25 fixes the composite color image (transferred color image) on the sheet (recording paper) through application of heat and pressure. Subsequently, the sheet (recording paper) is discharged from a discharge roller 56 by a switching claw 55 and then stacked on a discharge tray 57. Alternatively, the sheet (recording paper) is reversed with the sheet reversing device 28 by a switching claw 55 and conveyed again to a position where transfer is performed.

Thereafter, an image is formed on the back surface thereof, and then the thus-obtained sheet is discharged from a discharge roller 56 and stacked on a discharge tray 57.

The image forming method of the present invention can effectively provide a high-quality image, since it uses a two-component developer containing the carrier of the present invention capable of forming an image having high mechanical strength, involving neither toner scattering nor background smear, and having high image density.

### EXAMPLES

The present invention will next be described in mote detail by way of examples, which should not be construed as limiting the present invention thereto.

Firstly, there were produced toners and carriers used in two-component developers of Examples and Comparative Examples. The toners were produced in Production Examples 1 to 4, and the carriers were produced in Production Examples 5 to 11 and 11A to 20 16A. Each of Production Examples was described below.

### Production Example 1

### <Production of Toner 1>

### —Synthesis of Emulsion of Organic Microparticles—

A reaction vessel equipped with a stirrer and a thermometer was charged with water (683 parts by mass), a sodium salt of methacrylic acid ethylene oxide adduct sulfate (Eleminol RS-30, product of Sanyo Chemical Industries) (11 parts by mass), methacrylic acid (166 parts by mass), butyl acrylate (110 parts by mass) and ammonium persulfate (1 part by mass). The resultant mixture was stirred at 3,800 rpm for 30 min to form a white emulsion. The thus-formed emulsion was heated so that the temperature of the reaction system was increased to 75° C., followed by reaction for 4 hours. Subsequently, a 1% by mass aqueous ammonium persulfate solution (30 parts by mass) was added to the reaction mixture, followed by ripening at 75° C. for 6 hours, to thereby form a microparticle dispersion 1; i.e., an aqueous dispersion of a vinyl-based resin (a copolymer of methacrylic acid-butyl acrylate-sodium salt of methacrylic acid ethylene oxide adduct sulfate).

Through measurement with a particle size distribution analyzer (LA-920, product of Horiba, Ltd.), the thus-formed microparticle dispersion 1 was found to have a volume average particle diameter of 110 nm. A part of the microparticle dispersion 1 was dried and then resin was isolated. The thus-isolated resin was found to have a glass transition temperature (Tg) of 58° C. and weight average molecular weight of 130,000.

### —Preparation of Aqueous Phase—

Water (990 parts by mass), microparticle dispersion 1 (83 parts by mass), a 48.3% by mass aqueous solution of dodecyl diphenyl ether disulfonic acid sodium (Eleminol MON-7, product of Sanyo Chemical Industries) (37 parts by mass) and ethyl acetate (90 parts by mass) were mixed/stirred one another, to thereby form aqueous phase 1 as an opaque white liquid.

### —Synthesis of Low-Molecular-Weight Polyester—

A reaction vessel equipped with a condenser, a stirrer and a nitrogen-introducing tube was charged with an ethylene oxide 2-mole adduct of bisphenol A (229 parts by mass), a propylene oxide 3-mole adduct of bisphenol A (529 parts by mass), terephthalic acid (208 parts by mass), adipic acid (46 parts by mass) and dibutyltin oxide (2 parts by mass), and the mixture was allowed to react at 230° C. for 7 hours under normal pressure. Subsequently, the resultant mixture was allowed to react for 5 hours under reduced pressure (10 mmHg to mmHg). Thereafter, trimellitic anhydride (44 parts by mass) was added to the reaction vessel, followed by reaction at 180° C. for 3 hours under normal pressure, to thereby synthesize low-molecular-weight polyester 1.

The thus-obtained low-molecular-weight polyester 1 was found to have a number average molecular weight of 2,300, weight average molecular weight of 6,700, glass transition temperature (Tg) of 43° C., and acid value of 25 mgKOH/g.

### —Synthesis of Polyester Intermediate and Prepolymer—

A reaction vessel equipped with a condenser, a stirrer and a nitrogen-introducing tube was charged with an ethylene oxide 2-mole adduct of bisphenol A (682 parts by mass), a propylene oxide 2-mole adduct of bisphenol A (81 parts by mass), terephthalic acid (283 parts by mass), trimellitic anhydride (22 parts by mass) and dibutyltin oxide (2 parts by mass), and the mixture was allowed to react at 230° C. for 7 hours under normal pressure. Subsequently, the resultant mixture was allowed to react for 5 hours under reduced pressure (10 mmHg to 15 mmHg), to thereby synthesize polyester intermediate 1.

The thus-obtained polyester intermediate 1 was found to have a number average molecular weight of 2,200, weight average molecular weight of 9,700, glass transition temperature (Tg) of 54° C., acid value of 0.5 mgKOH/g and hydroxyl value of 52 mgKOH/g.

A reaction vessel equipped with a condenser, a stirrer and a nitrogen introducing tube was charged with the above-obtained polyester intermediate 1 (410 parts by mass), isophorone diisocyanate (89 parts by mass) and ethyl acetate (500 parts by mass), and the resultant mixture was allowed to react at 100° C. for 5 hours to prepare a prepolymer 1. The free isocyanate content of the thus-prepared prepolymer 1 was found to 1.53% by mass.

### —Synthesis of Ketimine—

A reaction vessel equipped with a stirring rod and a thermometer was charged with isophorone diamine (170 parts by mass) and methyl ethyl ketone (75 parts by mass), and the resultant mixture was allowed to react at 50° C. for 4.5 hours to prepare ketimine compound 1. The thus-prepared ketimine compound 1 was found to have an amine value of 417.

### —Synethesis of Masterbatch (MB)—

Water (1,200 parts by mass), carbon black (Printex 35, product of Deggusa Co., DBP oil-absorption amount: 42 mL/100 mg, pH: 9.5) (540 parts by mass) and the above-produced low-molecular-weight polyester resin 1 (1,200 parts by mass) were mixed one another with a Henschel mixer (product of Mitsui Mining Co.). Using a two-roll mill, the resultant mixture was kneaded at 110° C. for 1 hour, followed by calendering and cooling. The product was pulverized with a pulverizer to prepare masterbatch 1.

### —Preparation of Wax Dispersion—

A reaction vessel equipped with a stirrer and a thermometer was charged with the above-produced low-molecular weight polyester 1 (378 parts by mass), paraffin wax A (melting point: 78° C.) (110 parts by mass) and ethyl acetate (947 parts by mass). The mixture was increased to 80° C. under stirring and then maintained at 80° C. for 5 hours. The resultant mixture was cooled to 30° C. over 1 hour, to thereby produce wax dispersion (1). Through measurement with a particle size distribution analyzer employing laser scattering (LA-920, product of Horiba, Ltd.), the dispersed particles of the thus-produced wax dispersion (1) was found to have a volume average particle diameter (Dv) of 0.160 μm. Note that coarse particles having a volume average particle diameter (Dv) of 0.8 μm or more were found to be contained at a ratio of 5% or lower.

### —Preparation of Oil Phase—

The above-produced wax dispersion (1) (1,435 parts by mass), the above-produced masterbatch 1 (500 parts by mass) and ethyl acetate (500 parts by mass) were mixed one another for 1 hour, to thereby prepare a raw material solution.

A part (1,324 parts by mass) of the thus-prepared raw material solution was charged into a reaction vessel, and carbon black and wax were dispersed therein with a bead mill (Ultra Visco Mill, product of Aymex Co.) under the following conditions: liquid-feeding rate: 1 kg/hr; disc circumferential speed: 6 m/sec; amount of 0.5 mm-zirconia beads charged: 80% by volume; and pass time: 3. Subsequently, a 65% by mass ethyl acetate solution of the above-produced low-molecular-weight polyester 1 (1,324 parts by mass) was added to the dispersion. The resultant mixture was dispersed with the above bead mill under the following conditions: liquid-feeding rate: 1 kg/hr; disc circumferential speed: 6 m/sec; amount of 0.5 mm-zirconia beads charged: 80% by volume; and pass time: 1, to thereby prepare oil phase 1.

The thus-produced oil phase 1 was found to have a solid content of 50% by mass through measurement including heating at 130° C. for 30 min.

### —Emulsification and Solvent Removal—

A container was charged with oil phase 1 (749 parts by mass), prepolymer 1 (115 parts by mass) and ketimine compound 1 (2.9 parts by mass), and the resultant mixture was mixed with a TK Homomixer (product of Tokushu Kika Kogyo Co.) at 5,000 rpm for 2 min. Subsequently, aqueous phase 1 (1,200 parts by mass) was added to the container, followed by mixing with a TK Homomixer at 13,000 rpm for 25 min, to thereby produce emulsion slurry 1.

The thus-produced emulsion slurry 1 was charged into a container equipped with a stirrer and a thermometer, followed by solvent removal at 30° C. for 8 hours and then ripening at 40° C. for 24 hours, to thereby produce dispersion slurry 1.

### —Washing and Drying—

Dispersion slurry 1 (100 parts by mass) was filtrated under reduced pressure and then washed as follows:

(1) ion-exchange water (100 parts by mass) was added to the obtained filter cake, followed by mixing with a TK Homomixer (at 12,000 rpm for 10 min) and then filtration;
(2) 10% by mass aqueous sodium hydroxide solution (100 parts by mass) was added to the filter cake obtained in the above (1), followed by mixing with a TK Homomixer (at 12,000 rpm for 30 min) and then filtration under reduced pressure;
(3) 10% by mass hydrochloric acid (100 parts by mass) was added to the filter cake obtained in the above (2), followed by mixing with a TK Homomixer (at 12,000 rpm for 10 min) and then filtration; and
(4) ion-exchange water (300 parts by mass) was added to the filter cake obtained in the above (3), followed by mixing with a TK Homomixer (at 12,000 rpm for 10 min) and then filtration. Furthermore, ion-exchange water (300 parts by mass) was added again to the thus-obtained filter cake, followed by mixing with a TK Homomixer (at 12,000 rpm for 10 min) and then filtration, to thereby produce filter cake 1.

The thus-produced filter cake 1 was dried at 45° C. for 48 hours using an air-circulating drier, and then was caused to pass through a sieve with a mesh size of 75 μm, to thereby produce base toner particles having a volume average particle diameter of 6.1 μm, number average particle diameter of 5.4 μm, and average circularity of 0.972.

### —External Addition for Toner—

Subsequently, hydrophobic silica (0.7 parts by mass) and hydrophobic titanium oxide (0.3 parts by mass) were added to the thus-obtained toner base particles (100 parts by mass), followed by mixing with a Henschel mixer, to thereby produce toner 1 of Production Example 1. The thus-produced toner 1 was measured for its properties in a manner described above, and the results are shown in Table 2 given below.

### Production Example 2

### <Production of Toner 2>

There was produced wax dispersion (2) that was the same as wax dispersion (1) used in Production Example 1, except that paraffin wax A was changed to polypropylene wax (melting point: 86° C.). The procedure of Production Example 1 was repeated, except that the thus-produced wax dispersion (2) was used, to thereby produce toner 2 of Production Example 2. Through measurement with a particle size distribution analyzer employing laser scattering (LA-920, product of Horiba, Ltd.), the dispersed particles of wax dispersion (2) was found to have a volume average particle diameter (Dv) of 0.162 μm. Note that coarse particles having a volume average particle diameter (Dv) of 0.8 μm or more were found to be contained at a ratio of 5% or lower.

Similar to Production Example 1, the thus-produced toner 2 was measured for its properties, and the results are shown in Table 2 given below.

### Production Example 3

### <Production of Toner 3>

There was produced wax dispersion (3) that was the same as wax dispersion (1) used in Production Example 1, except that paraffin wax A (110 parts by mass) was changed to carnauba wax (660 parts by mass) (melting point: 82° C.). The procedure of Production Example 1 was repeated, except that the thus-produced wax dispersion (3) was used, to thereby produce toner 3 of Production Example 3.

Similar to Production Example 1, the thus-produced toner 3 was measured for its properties, and the results are shown in Table 2 given below.

### Production Example 4

### <Production of Toner 4>

A reaction vessel equipped with a condenser, a stirrer and a nitrogen-introducing tube was charged with an ethylene oxide 2-mole adduct of bisphenol A (724 parts by mass), isophthalic acid (276 parts by mass) and dibutyltin oxide (2 parts by mass), and the mixture was allowed to react at 230° C. for 8 hours under normal pressure. Subsequently, the resultant mixture was allowed to react for 5 hours under reduced pressure (10 mmHg to 15 mmHg) and then cooled to 160° C. Thereafter, phthalic anhydride (32 parts by mass) was added to the reaction mixture, followed by reaction for 2 hours. After cooled to 80° C., the resultant mixture was reacted with isophorone diisocyanate (188 parts by mass) for 2 hours in ethyl acetate, to thereby produce prepolymer 4. The thus-produced prepolymer 4 (267 parts by mass) was reacted with isophoronediamine (14 parts by mass) at 50° C. for 2 hours, to thereby produce a crosslinked polyester having a weight average molecular weight of 64,000.

The below-listed components (including the thus-produced crosslinked polyester, low-molecular-weight polyester 1 and masterbatch 1) were kneaded with a biaxial extruder at 100° C., followed by pulverizing and classification, to thereby produce toner particles. Subsequently, hydrophobic silica (0.7 parts by mass) and hydrophobic titanium oxide (0.3 parts by mass) were added to the thus-obtained toner particles (100 parts by mass), followed by mixing with a Henschel mixer, to thereby produce toner 4 of Production Example 4.

Similar to Production Example 1, the thus-produced toner 4 was measured for its properties, and the results are shown in Table 2 given below.

### <Formulation>

Low-molecular-weight polyester 1: 85 parts by mass
Crosslinked polyester: 15 parts by mass
Carnauba wax (melting point: 82° C.): 7 parts by mass
Masterbatch 1: 6 parts by mass
Charge controlling agent E-84 (product of Orient Chemical Industries, Ltd.): 1 part by mass

TABLE 2

| | | Wax | | | | Toner | | |
|---|---|---|---|---|---|---|---|---|
| | | | | | Amount of wax present | | Number | |
| | | | | | in the vicinity of toner | Volume | average | |
| | | | | Total wax | surface through | average | particle | |
| | | | | amount | FTIR-ATR | particle | diameter | |
| | | | m. p. | by DSC | spectroscopy | diameter | Dn | |
| Prodn. Ex. | Toner | Type | (° C.) | (% by mass) | (% by mass) | Dv (μm) | (μm) | Dv/Dn |
| Prodn. Ex. 1 | Toner 1 | Paraffin A | 78 | 3.8 | 1.8 | 5.2 | 4.6 | 1.13 |
| Prodn. Ex. 2 | Toner 2 | Polypropylene | 86 | 3.7 | 1.6 | 5.4 | 4.8 | 1.13 |
| Prodn. Ex. 3 | Toner 3 | Carnauba wax | 82 | 23 | 13.1 | 5.3 | 4.5 | 1.18 |
| Prodn. Ex. 4 | Toner 4 | Carnauba wax | 82 | 5.2 | 4.2 | 6.2 | 4.8 | 1.29 |

### Production Example 5

### <Production of Carrier 1>

A four-necked flask equipped with a nitrogen-introducing tube and a thermometer was charged with methyltrimethoxysilane (71.4 parts by mass), ethyl acetoacetate (12.5 parts by mass) and isopropyl alcohol (112.6 parts by mass), and the mixture was homogeneously stirred under nitrogen bubbling.

Separately, SNOWTEX040 (solid content: 40% by mass, NISSAN CHEMICAL INDUSTRIE, LTD.) (37.5 parts by mass), 1 mol/L aqueous acetic acid solution (4.5 parts by mass) and distilled water (11.1 parts by mass) were homogeneously mixed one another, and the resultant mixture was added dropwise to the four-necked flask using a dropping funnel with the internal temperature of the flask being maintained to 35° C. After completion of dropwise addition, the mixture was maintained at 35° C. for 30 min and then increased to 60° C. over 30 min, followed by reaction for 3 hours.

Subsequently, the resultant mixture was diluted with toluene so that the solid content was adjusted to 15% by mass. Thereafter, an aminosilane coupling agent (SH6020, solid content: 100% by mass, product of Dow Corning Toray Silicone Co., Ltd.) was added to the mixture so that the aminosilane coupling agent content was adjusted to 1% by mass with respect to the total solid content, followed by mixing with a Homomixer for 10 min, to thereby prepare coating liquid 1.

The thus-prepared coating liquid 1 was applied onto ferrite powder (saturation magnetic moment: 65 emu/g at 1 k Gauss), serving as core particles, using a tumbling fluidized coating apparatus so that the thickness of the coating layer was adjusted to 1.5 μm, followed by drying. The thus-formed carrier was left to stand in an electric furnace at 120° C. for 30 min for firing. After cooling, the ferrite powder bulk was pulverized with a sieve having a mesh size of 90 μm, to thereby produce carrier 1 of Production Example 5.

Through measurement with a Microtrack particle size analyzer (model HRA9320-X100), the thus-formed carrier 1 was found to have a weight average particle diameter (Dw) of 39.3 μm, number average particle diameter (Dn) of 34.5 μm, and a ratio Dw/Dn of 1.14. Also, the volume resistivity of carrier 1 was found to be 15.8 Log (Ω·cm). The thickness (h) of the coating layer of carrier 1 was found to be 1.43 μm as determined as follows: coated particles (carrier 1) were cut with a focused ion beam (FIB); the thus-formed cross-section surface was measured for its layer thicknesses at 50 sites or more through transmission electron microscopy (TEM) and scanning transmission electron microscopy (STEM); and the thus-obtained values were averaged. The thus-produced carrier 1 was measured for its properties in a manner described above, and the results are shown in Table 3 given below.

### Production Example 6

### <Production of Carrier 2>

The procedure of Production Example 5 was repeated, except that the components charged into the four-necked flask were changed from methyltrimethoxysilane (71.4 parts by mass), ethyl acetoacetate (12.5 parts by mass) and isopropyl alcohol (112.6 parts by mass) to methyltrimethoxysilane (64.2 parts by mass), methyl silicate-51 (0.9 parts by mass) (product of TAMA CHEMICALS CO., LTD.), hexyltrimethoxysilane (4.3 parts by mass), γ-glycidoxypropyltrimethoxysilane (2.1 parts by mass), ethyl acetoacetate (12.5 parts by mass), isopropyl alcohol (87.6 parts by mass), and isobutanol (25 parts by mass), to thereby produce carrier 2 of Production Example 6.

Similar to Production Example 5, the thus-produced carrier 2 was measured for its properties, and the results are shown in Table 3 given below.

### Production Example 7

### <Production of Carrier 3>

A four-necked flask equipped with a nitrogen-introducing tube and a thermometer was charged with methyltrimethoxysilane (71.4 parts by mass), ethyl acetoacetate (12.5 parts by mass) and isopropyl alcohol (112.6 parts by mass), and the mixture was homogeneously stirred under nitrogen bubbling.

Separately, SNOWTEX040 (solid content: 40% by mass, NISSAN CHEMICAL INDUSTRIE, LTD.) (37.5 parts by mass), 1 mol/L aqueous acetic acid solution (4.5 parts by mass) and distilled water (11.1 parts by mass) were homogeneously mixed one another, and the resultant mixture was added dropwise to the four-necked flask using a dropping funnel with the internal temperature of the flask being maintained to 35° C. After completion of dropwise addition, the mixture was maintained at 35° C. for 30 min and then increased to 60° C. over 30 min, followed by reaction for 3 hours.

Subsequently, spherical alumina microparticles having a particle diameter of 0.4 μm (40 parts by mass) were added to the resultant solution, and the resultant mixture was diluted with toluene so that the solid content was adjusted to 15% by mass. Thereafter, an aminosilane coupling agent (SH6020, solid content: 100% by mass, product of Dow Corning Toray Silicone Co., Ltd.) was added to the mixture so that the aminosilane coupling agent content was adjusted to 1% by mass with respect to the total solid content, followed by mixing with a Homomixer for 10 min, to thereby prepare coating liquid 3.

The thus-prepared coating liquid 3 was applied onto ferrite powder (saturation magnetic moment: 65 emu/g at 1 k Gauss), serving as core particles, using a tumbling fluidized coating apparatus so that the thickness of the coating layer was adjusted to 1.5 μm, followed by drying. The thus-formed carrier was left to stand in an electric furnace at 120° C. for 30 min for firing. After cooling, the ferrite powder bulk was pulverized with a sieve having a mesh size of 90 μm, to thereby produce carrier 3 of Production Example 7.

Similar to Production Example 5, the thus-produced carrier 3 was measured for its properties, and the results are shown in Table 3 given below.

### Production Example 8

### <Production of Carrier 4>

The procedure of Production Example 5 was repeated, except that the amount of SNOWTEX040 was changed from 37.5 parts by mass to 75 parts by mass, to thereby produce carrier 4 of Production Example 8.

Similar to Production Example 5, the thus-produced carrier 4 was measured for its properties, and the results are shown in Table 3 given below.

### Production Example 9

### <Production of Carrier 5>

The procedure of Production Example 5 was repeated, except that the coating liquid was applied onto ferrite powder so that the thickness of the coating layer was adjusted to 0.5 μm, to thereby produce carrier 5 of Production Example 9.

Similar to Production Example 5, the thus-produced carrier 5 was measured for its properties, and the results are shown in Table 3 given below.

### Production Example 10

### <Production of Carrier 6>

After the below-listed components had been mixed one another, the resultant mixture was diluted with toluene so that the solid content thereof was adjusted to 15%, followed by dispersion with a Homomixer for 10 min, to thereby prepare coating liquid 6.

### <Components>

Acrylic resin solution (Hitaloid 3018, solid content: 50% by mass, product of Hitachi Chemical Co., Ltd.): 30 parts by mass Guanamine solution (Mycoat 106, solid content: 77% by mass, product of MITUSI SYTEC Co., LTD.): 10 parts by mass Silicone resin solution (SR2405, solid content: 50% by mass, product of Dow Corning Toray Silicone Co., Ltd.): 60 parts by mass Aminosilane coupling agent (SH6020, solid content: 100% by mass, product of Dow Corning Toray Silicone Co., Ltd.): 1 part by mass Spherical alumina microparticles having a particle diameter of 0.4 μm: 40 parts by mass

The thus-prepared coating liquid 6 was applied onto ferrite powder (saturation magnetic moment: 65 emu/g at 1 k Gauss), serving as core particles, using a tumbling fluidized coating apparatus so that the thickness of the coating layer was adjusted to 1.5 μm, followed by drying. The thus-formed carrier was left to stand in an electric furnace at 120° C. for 30 min for firing. After cooling, the ferrite powder bulk was pulverized with a sieve having a mesh size of 90 μm, to thereby produce carrier 6 of Production Example 10.

Similar to Production Example 5, the thus-produced carrier 6 was measured for its properties, and the results are shown in Table 3 given below.

### Production Example 11

### <Production of Carrier 7>

Zn(OAc)₂.2H₂O (13.5 parts by mass) was dissolved in a liquid mixture of water (62 parts by mass) and ethanol (75 parts by mass). Subsequently, 6N hydrochloric acid (2 parts by mass) was added to the solution, followed by refluxing for 30 min. Thereafter, the resultant mixture was diluted with acetic acid (5 parts by mass), 1-butanol (10 parts by mass), 2-ethoxyethanol (20 parts by mass) and diethylene glycol (5 parts by mass). An aminosilane coupling agent (SH6020, solid content: 100% by mass, product of Dow Corning Toray Silicone Co., Ltd.) was added to the thus-diluted solution so that the aminosilane coupling agent content was adjusted to 1% by mass with respect to the total solid content, to thereby prepare coating liquid 7.

The thus-prepared coating liquid 7 was applied onto ferrite powder (saturation magnetic moment: 65 emu/g at 1 k Gauss), serving as core particles, using a tumbling fluidized coating apparatus so that the thickness of the coating layer was adjusted to 1.5 μm, followed by drying. The thus-formed carrier was left to stand in an electric furnace at 200° C. for 120 min for firing. After cooling, the ferrite powder bulk was pulverized with a sieve having a mesh size of 90 μm, to thereby produce carrier 7 of Production Example 11.

Similar to Production Example 5, the thus-produced carrier 7 was measured for its properties, and the results are shown in Table 3 given below.

TABLE 3

| | | | | | Weight | Number | | | |
|---|---|---|---|---|---|---|---|---|---|
| | | Colloidal silica | | | average | average | | | |
| | | content of the | Molecular weight | Thickness | particle | particle | | | Volume |
| | | coating layer | of condensate of | of coating | diameter | diameter | | | resistivity |
| Prodn. Ex. | Carrier | (% by mass) | alkoxysilane | layer (μm) | Dw (μm) | Dn (μm) | Dw/Dn | h/Dw | (logΩ · cm) |
| Prodn. Ex. 5 | Carrier 1 | 30 | 670 | 1.43 | 39.3 | 34.5 | 1.14 | 0.04 | 15.8 |
| Prodn. Ex. 6 | Carrier 2 | 30 | 820 | 1.38 | 38.9 | 33.9 | 1.15 | 0.04 | 15.1 |
| Prodn. Ex. 7 | Carrier 3 | 21 | 670 | 1.41 | 39.1 | 34.6 | 1.13 | 0.04 | 14.5 |
| Prodn. Ex. 8 | Carrier 4 | 60 | 750 | 1.36 | 38.4 | 33.5 | 1.15 | 0.04 | 15.3 |
| Prodn. Ex. 9 | Carrier 5 | 30 | 670 | 0.43 | 37.9 | 32.9 | 1.15 | 0.01 | 13.6 |
| Prodn. Ex. 10 | Carrier 6 | 0 | — | 1.45 | 39.6 | 34.1 | 1.16 | 0.04 | 15.5 |
| Prodn. Ex. 11 | Carrier 7 | 0 | — | 1.46 | 39.2 | 33.7 | 1.16 | 0.04 | 15.4 |

### —Carrier—

### Production Example A-5

### <Production of Colloidal Silica-Alkoxysilane Condensate Liquid A-1>

A four-necked flask equipped with a nitrogen-introducing tube and a thermometer was charged with methyltrimethoxysilane (71.4 parts by mass), ethyl acetoacetate (12.5 parts by mass) and isopropyl alcohol (112.6 parts by mass), and the mixture was homogeneously stirred under nitrogen bubbling.

Separately, SNOWTEX040 (solid content: 40% by mass, NISSAN CHEMICAL INDUSTRIE, LTD.) (37.5 parts by mass), 1 mol/L aqueous acetic acid solution (4.5 parts by mass) and distilled water (11.1 parts by mass) were homogeneously mixed one another, and the resultant mixture was added dropwise to the four-necked flask using a dropping funnel with the internal temperature of the flask being maintained to 35° C. After completion of dropwise addition, the mixture was maintained at 35° C. for 30 min and then increased to 60° C. over 30 min, followed by reaction for 3 hours. The resultant solution was diluted with toluene so that the solid content was 20% by mass, to thereby produce colloidal silica-alkoxysilane condensate liquid A-1.

### Production Example A-6

### <Production of Colloidal Silica-Alkoxysilane Condensate Liquid A-2>

The procedure of Production Example A-5 was repeated, except that the components charged into the four-necked flask were changed from methyltrimethoxysilane (71.4 parts by mass), ethyl acetoacetate (12.5 parts by mass) and isopropyl alcohol (112.6 parts by mass) to methyltrimethoxysilane (64.2 parts by mass), methyl silicate-51 (0.9 parts by mass) (product of TAMA CHEMICALS CO., LTD.), hexyltrimethoxysilane (4.3 parts by mass), γ-glycidoxypropyltrimethoxysilane (2.1 parts by mass), ethyl acetoacetate (12.5 parts by mass), isopropyl alcohol (87.6 parts by mass), and isobutanol (25 parts by mass), to thereby produce colloidal silica-alkoxysilane condensate liquid A-2 of Production Example A-6.

### Production Example A-7

### <Production of Colloidal Silica-Alkoxysilane Condensate Liquid A-3>

The procedure of Production Example A-5 was repeated, except that the amount of SNOWTEX040 was changed from 37.5 parts by mass to 75 parts by mass, to thereby produce colloidal silica-alkoxysilane condensate liquid A-3 of Production Example A-7.

### Production Example A-8

### <Production of Colloidal Silica-Alkoxysilane Condensate Liquid A-4>

The procedure of Production Example A-5 was repeated, except that the amount of SNOWTEX040 was changed from 37.5 parts by mass to 95 parts by mass, to thereby produce colloidal silica-alkoxysilane condensate liquid A-4 of Production Example A-8.

### Production Example A-9

### <Production of Conductive Alumina Microparticles>

Aluminum oxide (Sumicorundum AA-04, particle diameter: 0.4 μm, product of Sumitomo Chemical Co., Ltd.) (200 parts by mass) was dispersed in water (2,500 parts by mass). The thus-formed aqueous suspension was maintained at 80° C. with heating. Separately, indium chloride (InCl₃) (75 parts by mass) was dissolved in 2N hydrochloric acid (800 parts by mass). The resultant solution and a 12% by mass aqueous ammonia were added dropwise to the above-prepared suspension so that the pH thereof was adjusted to 7 to 8. The suspension obtained after completion of dropwise addition was filtrated and washed, and the formed cake was dried at 120° C.

Subsequently, the thus-obtained dry powder was treated under a nitrogen gas flow (1 L/min) at 500° C. for 1.5 hours, to thereby produce conductive alumina microparticles of interest.

### Production Example A-10

<Production of Alumina Microparticles Surface-Treated with Aminosilaminosminosilane Surface-Treated Alumina Microparticles)>

Aluminum oxide (Sumicorundum AA-04, particle diameter: 0.4 μm, product of Sumitomo Chemical Co., Ltd.) (200 parts by mass) was dispersed in water (2,500 parts by mass). Aminosilane coupling agent (SH6020, solid content: 100% by mass, product of Dow Corning Toray Silicone Co., Ltd.) (10 parts by mass) was added to the formed aqueous suspension under stirring, followed by filtration. Thereafter, water and toluene were sequentially added to the resultant mixture to dissolve the residual aminosilane coupling agent for removal. The thus-formed powder was dried and pulverized, to thereby produce aminosilane surface-treated alumina microparticles of interest.

### Production Example A-11

<Production of carrier A-1>

After the below-listed components had been mixed one another, the resultant mixture was diluted with methyl ethyl ketone so that the solid content thereof was adjusted to 15%, followed by dispersion with a Homomixer for 10 min, to thereby prepare coating liquid A-1. The relative solid amounts of the components contained in the coating liquid are shown in Table 4.
Acrylic resin solution (Hitaloid 3018, solid content: 50% by mass, product of Hitachi Chemical Co., Ltd.): 42 parts by mass
Guanamine solution (Mycoat 106, solid content: 77% by mass, product of MITUSI SYTEC Co., LTD.): 11.7 parts by mass
Colloidal silica-alkoxysilane condensate liquid A-1 (solid content: 20% by mass): 175 parts by mass
Alumina microparticles (Sumicorundum AA-04, particle diameter: 0.4 μm, product of Sumitomo Chemical Co., Ltd.): 20 parts by mass
Conductive alumina microparticles: 15 parts by mass

The thus-prepared coating liquid A-1 was applied onto ferrite powder (saturation magnetic moment: 65 emu/g at 1 k Gauss), serving as core particles, using a tumbling fluidized coating apparatus so that the thickness of the coating layer was adjusted to 1.5 μm, followed by drying. The thus-formed carrier was left to stand in an electric furnace at 120° C. for 30 min for firing. After cooling, the ferrite powder bulk was pulverized with a sieve having a mesh size of 90 μm, to thereby produce carrier A-1 of Production Example A-11.

Through measurement with a Microtrack particle size analyzer (model HRA9320-X100), the thus-formed carrier A-1 was found to have a weight average particle diameter (Dw) of 41.2 μm, number average particle diameter (Dn) of 36.2 μm, and a ratio Dw/Dn of 1.14. Also, the volume resistivity of carrier A-1 was found to be 15.4 Log (Ω·cm). The thickness (h) of the coating layer of carrier A-1 was found to be 1.47 μm as measured as follows: coated particles (carrier A-1) were cut with a focused ion beam (FIB); the thus-formed cross-section surface was measured for layer thicknesses at 50 sites or more through transmission electron microscopy (TEM) and scanning transmission electron microscopy (STEM); and the thus-obtained values were averaged.

### Production Example A-12

### <Production of Carrier A-2>

The procedure of Production Example A-11 was repeated, except that coating liquid A-1 was changed to coating liquid A-2 containing the below-listed components, to thereby produce carrier A-2 of Production Examples A-12.
Acrylic resin solution (Hitaloid 3018, solid content: 50% by mass, product of Hitachi Chemical Co., Ltd.): 21 parts by mass
Guanamine solution (Mycoat 106, solid content: 77% by mass, product of MITUSI SYTEC Co., LTD.): 5.84 parts by mass
Colloidal silica-alkoxysilane condensate liquid A-2 (solid content: 20% by mass): 250 parts by mass
Alumina microparticles (Sumicorundum AA-04, particle diameter: 0.4 μm, product of Sumitomo Chemical Co., Ltd.): 10 parts by mass
Conductive alumina microparticles: 15 parts by mass
Aminosilane surface-treated alumina microparticles: 10 parts by mass

The relative solid amounts of the components contained in the coating liquid are shown in Table 4. Also, similar to Production Example A-11, the thus-produced carrier A-2 was measured for its properties, and the results are shown in Table 5.

### Production Example A-13

### <Production of Carrier A-3>

The procedure of Production Example A-11 was repeated, except that coating liquid A-1 was changed to coating liquid A-3 containing the below-listed components, to thereby produce carrier A-3 of Production Examples A-13.
Acrylic resin solution (Hitaloid 3018, solid content: 50% by mass, product of Hitachi Chemical Co., Ltd.): 7 parts by mass
Guanamine solution (Mycoat 106, solid content: 77% by mass, product of MITUSI SYTEC Co., LTD.): 1.95 parts by mass
Colloidal silica-alkoxysilane condensate liquid A-3 (solid content: 20% by mass): 300 parts by mass
Conductive alumina microparticles: 15 parts by mass
Aminosilane surface-treated alumina microparticles: 20 parts by mass

The relative solid amounts of the components contained in the coating liquid are shown in Table 4. Also, similar to Production Example A-11, the thus-produced carrier A-3 was measured for its properties, and the results are shown in Table 5.

### Production Example A-14

### <Production of Carrier A-4>

The procedure of Production Example A-11 was repeated, except that coating liquid A-1 was changed to coating liquid A-4 containing the below-listed components, to thereby produce carrier A-4 of Production Examples A-14.
Colloidal silica-alkoxysilane condensate liquid A-4 (solid content: 20% by mass): 425 parts by mass
Conductive alumina microparticles: 15 parts by mass

The relative solid amounts of the components contained in the coating liquid are shown in Table 4. Also, similar to Production Example A-11, the thus-produced carrier A-4 was measured for its properties, and the results are shown in Table 5.

### Production Example A-15

### <Production of Carrier A-5>

The procedure of Production Example A-12 was repeated, except that the coating liquid was applied onto ferrite powder so that the thickness of the coating layer was adjusted to 0.5 μm, to thereby produce carrier A-5 of Production Example A-15.

The relative solid amounts of the components contained in the coating liquid are shown in Table 4. Also, similar to Production Example A-11, the thus-produced carrier A-5 was measured for its properties, and the results are shown in Table 5.

### Production Example A-16

### <Production of Carrier A-6>

The procedure of Production Example A-11 was repeated, except that coating liquid A-I was changed to coating liquid A-6 containing the below-listed components, to thereby produce carrier A-6 of Production Examples A-16.
Acrylic resin solution (Hitaloid 3018, solid content: 50% by mass, product of Hitachi Chemical Co., Ltd.): 63 parts by mass
Guanamine solution (Mycoat 106, solid content: 77% by mass, product of MITUSI SYTEC Co., LTD.): 17.5 parts by mass
Silicone resin solution (SR2405, solid content: 50% by mass, product of Dow Corning Toray Silicone Co., Ltd.): 40 parts by mass
Alumina microparticles (Sumicorundum AA-04, particle diameter: 0.4 μm, product of Sumitomo Chemical Co., Ltd.): 15 parts by mass
Conductive alumina microparticles: 15 parts by mass
Aminosilane coupling agent (SH6020, solid content: 100% by mass, product of Dow Corning Toray Silicone Co., Ltd): 5 parts by mass

The relative solid amounts of the components contained in the coating liquid are shown in Table 4. Also, similar to Production Example A-11, the thus-produced carrier A-6 was measured for its properties, and the results are shown in Table 5.

TABLE 4

| | Relative solid amounts of components contained in coating liquid (% by mass) | | | | | | | | | | |
|---|---|---|---|---|---|---|---|---|---|---|---|
| | | | | | | | | | | | Amino |
| | | | Colloidal | | | | | | | Aminosilane | silane |
| | | | silica-alkoxysilane | | | | | Alumina | Conductive | surface-treated | (added to |
| | Acrylic | Amino | condensate liquid | | | | Silicone | micro- | alumina | alumina | coating |
| | resin | resin | A-1 | A-2 | A-3 | A-4 | resin | particles | microparticles | microparticles | liquid) |
| Carrier A-1 | 21 | 9 | 35 | — | — | — | — | 20 | 15 | — | — |
| Carrier A-2 | 10.5 | 4.5 | — | 50 | — | — | — | 10 | 15 | 10 | — |
| Carrier A-3 | 3.5 | 1.5 | — | — | 60 | — | — | 0 | 15 | 20 | — |
| Carrier A-4 | — | — | — | — | — | 85 | — | 0 | 15 | 0 | — |
| Carrier A-5 | 10.5 | 4.5 | — | 50 | — | — | — | 10 | 15 | 10 | — |
| Carrier A-6 | 31.5 | 13.5 | — | — | — | — | 20 | 15 | 15 | — | 5 |

TABLE 5

| | | | | | Weight | Number | | | |
|---|---|---|---|---|---|---|---|---|---|
| | | Colloidal silica | Molecular | Thickness | average | average | | | |
| | | content of the | weight of | of coating | particle | particle | | | Volume |
| | | coating layer | condensate of | layer h | diameter | diameter | | | resistivity |
| | | (% by mass) | alkoxysilane | (μm) | Dw (μm) | Dn (μm) | Dw/Dn | h/Dw | (logΩ · cm) |
| Prodn. Ex. A-11 | Carrier A-1 | 10.5 | 670 | 1.47 | 41.2 | 36.2 | 1.14 | 0.04 | 15.4 |
| Prodn. Ex. A-12 | Carrier A-2 | 15 | 820 | 1.42 | 40.5 | 35.9 | 1.13 | 0.04 | 15.3 |
| Prodn. Ex. A-13 | Carrier A-3 | 36 | 750 | 1.45 | 41.3 | 35.8 | 1.15 | 0.04 | 15.7 |
| Prodn. Ex. A-14 | Carrier A-4 | 60 | 690 | 1.39 | 39.8 | 34.5 | 1.15 | 0.03 | 14.9 |
| Prodn. Ex. A-15 | Carrier A-5 | 15 | 820 | 0.46 | 41.6 | 36.2 | 1.15 | 0.01 | 13.4 |
| Prodn. Ex. A-16 | Carrier A-6 | — | — | 1.41 | 40.1 | 35.3 | 1.14 | 0.04 | 14.5 |

### Examples 1 to 12 and Comparative Examples 1 to 14

Each of the above-produced toners 1 to 4 and each of the above-produced carries 1 to 7 and A-1 to A-6 were mixed each other as shown in Tables 6 and 7, to thereby prepare a two-component developer. Specifically, these were mixed each other so that the coverage of the carrier with the toner was adjusted to 50% using a turblar mixer (product of Shinmaru Enterprises Corporation), to thereby prepare developers of Examples 1 to 12 and Comparative Examples 1 to 14.

Under the following conditions, each of the thus-prepared developers was evaluated for delamination and abrasion of the carrier coating layer, the degree of toner spent (charging stability), image density, toner scattering and background smear. The results are shown in Tables 6 and 7 given below.

### <Evaluation of Delamination and Abrasion of Carrier Coating Layer>

A running of 200,000-printing was performed with a tandem color image forming apparatus (imagio Neo450, product of Ricoh Company Ltd.) using the developer. Subsequently, the ratio of run carrier-resistivity to initial carrier-resistivity was evaluated according to the following evaluation criteria.

[Evaluation criteria]
A: 1/10≦Resistivity after 200,000-printing/initial resistivity≦1
B: 1/100≦Resistivity after 200,000-printing/initial resistivity< 1/10
C: 1/1,000≦Resistivity after 200,000-printing/initial resistivity<1/100
D: Resistivity after 200,000-printing/initial resistivity< 1/1,000

As used herein the “ratio of run carrier-resistivity to initial carrier-resistivity” refers to a value calculated by dividing a volume resistivity R2 of the carrier after running by a volume resistivity R1 of the initial carrier. The volume resistivity R1 is measured as follows: the initial carrier is charged into a gap (2 mm) between resistivity-measuring parallel electrodes, followed by application of a DC voltage of 200V; a resistivity after 30 sec from the application of voltage is measured with the High Resistance Meter (product of Yokokawa-HEWLETT-PACKARD); and the thus-obtained value is converted to a volume resistivity (R1). Meanwhile, the volume resistivity R2 is measured as follows: from the developer after running, the toner is removed using a blow-off device to prepare a carrier; and the carrier is subjected to similar measurement/conversion to the above case of the volume resistivity R1.

### <Evaluation of Degree of Toner Spent (Charging Stability)>

200,000 sheets having a chart with an image area ratio of 20% were formed with a tandem color image forming apparatus (imagio Neo450, product of Ricoh Company Ltd.) using the developer. In this printing, the concentration of toner was controlled so that the density of the formed image was adjusted to 1.4±0.2. The ratio of the charging amount of the developer after running (μc/g) to that of the initial developer was evaluated according to the following evaluation criteria. Note that the charging amount was measured by the blow-off method.

### [Evaluation Criteria]

A: 0.7<Charging amount after 200,000-printing/initial charging amount≦1
B: 0.5<Charging amount after 200,000-printing/initial charging amount≦0.7
C: Charging amount after 200,000-printing/initial charging amount≦0.5

The state of the outermost surface of a carrier is changed through application of mechanical stress caused by toner spent, resulting in decrease in the charging amount of the carrier. Developers exhibiting a larger ratio of the charging amount after 200,000-printing to the initial charging amount can be considered involving less toner spent and less change in the state of the coating layer surface, and having excellent durability.

### <Evaluation of Image Density>

Using a tandem color image forming apparatus (imagio Neo 450, product of Ricoh Company Ltd.) using the developer, a solid image was repeatedly formed on 200,000 sheets of copy paper (TYPE6000<70W>, product of Ricoh Company Ltd.) in an amount of the developer deposited of 1.00±0.05 mg/cm².

In an initial state or after printing of 200,000 sheets, the formed solid image was visually evaluated according to the following evaluation criteria. Note that developers evaluated as providing an image having higher image density can form an image having high image density. This evaluation corresponds to Example of the developer and the image forming method of the present invention.

[Evaluation criteria]
A: No change in image density observed in an initial state and after printing of 200,000 sheets, and high-quality image obtained
B: Slight decrease in image density observed after printing of 200,000 sheets, but high-quality image obtained
C: Decrease in image density observed after printing of 200,000 sheets, and image quality decreased
D: Considerable decrease in image density observed after printing of 200,000 sheets, and image quality considerably decreased

### <Evaluation of Toner Scattering>

Using a tandem color image forming apparatus (imagio Neo 450, product of Ricoh Company Ltd.) using the developer, 200,000 sheets having a chart with an image area ratio of 5% were continuously printed out. After printing, the interior of the apparatus was visually evaluated for the degree of toner scattering according to the following four evaluation criteria.

### [Evaluation Criteria]

A: No toner scattering observed in image forming apparatus, and in excellent conditions
B: No toner scattering observed in image forming apparatus, and in good conditions
C: Toner scattering observed in image forming apparatus, but practically applicable
D: Severe toner scattering observed in image forming apparatus, and practically non-applicable

### <Evaluation of Background Smear>

Using a tandem color image forming apparatus (imagio Neo 450, product of Ricoh Company Ltd.) using the developer, 200,000 sheets having a chart with an image area ratio of 5% were continuously printed out. The background of the image formed after printing of 200,000 sheets was visually evaluated for the degree of background smear according to the following evaluation criteria.

### [Evaluation Criteria]

A: No background smear observed
B: Background smear slightly observed but allowable
C: Background smear observed
D: Background smear severely observed

### <Comprehensive Evaluation>

The developer was comprehensively evaluated based on the above evaluation results according to the following evaluation criteria.

### [Evaluation Criteria]

A: Excellent
B: Good
C: Bad

TABLE 6

| | | | | Toner spent | | | | |
|---|---|---|---|---|---|---|---|---|
| | Developer | | Delamination/abrasion | (charging | Image | Toner | Background | Comprehensive |
| Ex./Comp. Ex. | Carrier | Toner | of coating layer | stability) | density | scattering | smear | evaluation |
| Ex. 1 | Carrier 1 | Toner 1 | B | A | B | A | B | B |
| Ex. 2 | Carrier 1 | Toner 2 | A | A | A | A | A | A |
| Ex. 3 | Carrier 2 | Toner 1 | B | A | B | A | A | A |
| Ex. 4 | Carrier 2 | Toner 2 | A | A | A | B | B | A |
| Ex. 5 | Carrier 3 | Toner 1 | A | B | B | A | B | B |
| Ex. 6 | Carrier 3 | Toner 2 | A | A | B | A | A | A |
| Comp. Ex. 1 | Carrier 1 | Toner 3 | B | C | C | D | C | D |
| Comp. Ex. 2 | Carrier 2 | Toner 4 | B | C | C | C | C | D |
| Comp. Ex. 3 | Carrier 4 | Toner 1 | D | B | D | D | C | D |
| Comp. Ex. 4 | Carrier 5 | Toner 1 | D | B | D | D | D | D |
| Comp. Ex. 5 | Carrier 5 | Toner 3 | C | C | D | D | D | D |
| Comp. Ex. 6 | Carrier 6 | Toner 2 | C | B | C | D | C | D |
| Comp. Ex. 7 | Carrier 6 | Toner 4 | C | C | C | D | D | D |
| Comp. Ex. 8 | Carrier 7 | Toner 2 | C | C | C | C | C | D |

TABLE 7

| | | | | Toner spent | | | | |
|---|---|---|---|---|---|---|---|---|
| | Developer | | Delamination/abrasion | (charging | Image | Toner | Background | Comprehensive |
| | Carrier | Toner | of coating layer | stability) | density | scattering | smear | evaluation |
| Ex. 7 | Carrier A-1 | Toner 1 | B | A | A | B | B | B |
| Ex. 8 | Carrier A-1 | Toner 2 | A | A | B | B | B | B |
| Ex. 9 | Carrier A-2 | Toner 1 | A | A | B | A | B | A |
| Ex. 10 | Carrier A-2 | Toner 2 | B | A | A | A | B | A |
| Ex. 11 | Carrier A-3 | Toner 1 | A | A | A | B | B | A |
| Ex. 12 | Carrier A-3 | Toner 2 | A | A | A | A | B | A |
| Comp. Ex. 9 | Carrier A-1 | Toner 3 | B | C | D | C | C | D |
| Comp. Ex. 10 | Carrier A-2 | Toner 4 | B | C | D | C | D | D |
| Comp. Ex. 11 | Carrier A-4 | Toner 1 | D | B | D | D | D | D |
| Comp. Ex. 12 | Carrier A-5 | Toner 1 | D | C | C | D | D | D |
| Comp. Ex. 13 | Carrier A-5 | Toner 3 | D | C | D | D | D | D |
| Comp. Ex. 14 | Carrier A-6 | Toner 2 | C | C | D | C | D | D |

As is clear from Table 6, the developers of Examples 1 to 6 were found to involve less delamination and abrasion of the coating layer, toner spent, toner scattering and background smear, and to provide an image having higher image density, as compared with those of Comparative Examples 1 to 8, and were comprehensively evaluated as “excellent” or “good.”

The developer of Comparative Example 1 was found to involve severe toner spent and toner scattering, since the amount of wax present in a region from the surface of toner 3 to a depth of 0.3 μm considerably exceeded the preferable upper limit (i.e., the amount of wax was 4% by mass or more)—considerably deviated from the more preferable range specified above (0.1% by mass or more and less than 4% by mass). The developer of Comparative Example 2 was found to involve rather good toner scattering evaluated as “C” but still involve severe toner spent; i.e., the ratio of the charging amount of the developer after running to that of the initial developer was found to be 0.5 or smaller, since the amount of wax present in a region from the surface of toner 4 to a depth of 0.3 μm slightly exceeded 4% by mass.

The developer of Comparative Example 3 was found to exhibit the practically applicable result in relation to only toner spent, since the amount of colloidal silica contained in carrier 4 was 60% by mass or more—deviated from the more preferable range specified above (0.5% by mass to 50% by mass). In other words, when the thickness of the coating layer was controlled so that the ratio (h/Dw) of the thickness (h) of the coating layer to the weight average particle diameter (Dw) of the carrier satisfied the relation 0.025<h/Dw<0.2, excessive colloidal silica impared the strength of the carrier coating layer, resulting in deterioration of image quality due to delamination and/or abrasion of the layer.

The carrier contained in the developer of Comparative Example 4 or 5 was found to have no coating layer sufficiently durable to long-term running, since the ratio (h/Dw) of the thickness (h) of the coating layer to the weight average particle diameter (Dw) of the carrier was 0.01—deviated from the more preferable range specified above (0.025<h/Dw<0.2). Thus, delamination and/or abrasion of the coating layer proceeded over time, resulting in toner scattering, background smear, and deterioration of image density.

The developer of Comparative Example 1 or 5 was found to involve severe toner spent attributed to wax, since the amount of wax present in the vicinity of the toner surface was as large as 13.1% by mass.

The developer of Comparative Example 2 or 7, containing the toner produced by the pulverization method, was found to also involve severe toner spent. The developer of Comparative Example 7 or 8 was found to exhibit unsatisfactory results, since it used materials different from the coating layer binding material used in the present invention which contains colloidal silica with a specific structure and a condensate of alkoxysilane.

As is clear from the above discussion, use of the carrier of the present invention or the two-component developer containing this carrier and the toner in which the amount of the releasing agent present in the surface has been controlled realizes long-term image formation without problems relating to toner spent, image density, toner scattering, background smear, and delamination and/or abrasion of the coating layer.

As is clear from Table 7, the developers of Examples 7 to 12 were found to involve less delamination and abrasion of the coating layer, to exhibit better long-term charging stability, to involve less toner scattering and background smear, and to provide an image having higher image density, as compared with those of Comparative Examples 9 to 14.

The developer of Comparative Example 11 contained no aminosilane coupling agent or amino resin responsible for controlling the charging amount of the carrier and thus, had insufficient charging ability for toner, resulting in severe toner scattering and background smear. Also, excessive colloidal silica impared the strength of the carrier coating layer, resulting in deterioration of image quality due to delamination and/or abrasion of the layer. The developer of Comparative Example 14, in which the charging ability of carrier for toner had been controlled by adding an aminosilane coupling agent to the coating liquid for the carrier coating layer, was found to exhibit degraded charging stability over time, as compared with the developer of each of Examples 9 to 12, in which the carrier had been prepared by using aminosilane surface-treated alumina microparticles. In the developer of Comparative Example 12 or 13, the ratio (h/Dw) of the thickness of the carrier coating layer (h) to the weight average particle diameter (Dw) of the carrier did not satisfy the relation 0.025<h/Dw<0.2. The formed coating layer, therefore, did not have sufficient long-term durability and thus was peeled off or abraded over time, resulting in degradation of image density, toner scattering and background smear. The developer of Comparative Example 9 or 14 was found to involve severe toner spent attributed to wax and degraded charging stability, since the amount of wax present in the vicinity of the toner surface was more than 4% by mass. The developer of Comparative Example 10, containing the toner produced by the pulverization method, was found to also involve severe toner spent.

What is claimed is:

1. A carrier comprising:
core particles composed of a magnetic material, and
a coating layer formed on surfaces of the core particles,
wherein the coating layer is formed by applying a coating liquid containing at least colloidal silica, a condensate of alkoxysilane represented by the following General Formula (1) and a solvent onto the surfaces of the core particles; an amount of colloidal silica contained in the coating layer is less than 60% by mass; and a ratio (h/Dw) of a thickness (h) of the coating layer to a weight average particle diameter (Dw) of the carrier is more than 0.01,
wherein the carrier is used in a two-component developer together with a toner which is produced through aqueous granulation and contains at least a colorant, a binder resin and a releasing agent, and
wherein an amount of the releasing agent present in a region from a surface of the toner to a depth of 0.3 μm is less than 4% by mass as measured through Fourier transform infrared-attenuated total reflection (FTIR-ATR) spectroscopy,
Si(R¹)ₐ(R²)₄₋ₐ General Formula (1)
wherein R¹ represents an alkyl group having 1 to 10 carbon atoms; R² represents an alkoxy group having 1 to 10 carbon atoms, alkenyloxy group having 1 to 10 carbon atoms, acyloxy group having 1 to 10 carbon atoms or alkoxyalkoxy group having 1 to 10 carbon atoms; and a is an integer of 0, 1 or 2.

2. The carrier according to claim 1, wherein the amount of colloidal silica contained in the coating layer is 0.5% by mass to 50% by mass.

3. The carrier according to claim 1, wherein the coating liquid further contains an amino resin, an acrylic resin capable of reacting with the amino resin, and microparticles.

4. The carrier according to claim 3, wherein an amount of the acrylic resin contained in the coating layer is 0.5% by mass to 30% by mass.

5. The carrier according to claim 3, wherein an amount of the microparticles contained in the coating layer is 1% by mass to 60% by mass.

6. The carrier according to claim 3, wherein the microparticles are microparticles whose surfaces have been treated with an aminosilane coupling agent.

7. The carrier according to claim 3, wherein the microparticles are conductive microparticles whose surfaces have been treated so as to have conductivity.

8. The carrier according to claim 3, wherein the coating liquid contains at least two types of microparticle.

9. The carrier according to claim 1, wherein the h/Dw satifies the relation 0.025<h/Dw<0.2.

10. The carrier according to claim 1, having a weight average particle diameter Dw of 20 μm to 65 μm.

11. The carrier according to claim 1, wherein the condensate of alkoxysilane represented by General Formula (1) has a molecular weight of 1,000 or lower.

12. The carrier according to claim 1, wherein the coating layer is formed by applying onto surfaces of the core particles a coating liquid which contains an aminosilane coupling agent in addition to the colloidal silica, the condensate and the solvent.

13. The carrier according to claim 1, wherein the carrier has a volume resistivity R of 10 Log (Ω·cm) to 16 Log (Ω·cm) as calculated based on a resistivity r, using the following Equation (1), the resistivity r being measured when the carrier is charged into a cell having electrodes 1 and 2 which are disposed 0.2 cm apart and which each have a surface area of 2.5 cm×4 cm under application of a DC voltage of 1,000V between the electrodes 1 and 2.
R=Log [r×(2.5 cm×4 cm)÷0.2 cm] Equation (1)

14. A two-component developer comprising:
a carrier which comprises core particles composed of a magnetic material and a coating layer formed on surfaces of the core particles,
a toner which is produced through aqueous granulation and contains at least a colorant, a binder resin and a releasing agent,
wherein the coating layer is formed by applying a coating liquid containing at least colloidal silica, a condensate of alkoxysilane represented by the following General Formula (1) and a solvent onto the surfaces of the core particles; an amount of colloidal silica contained in the coating layer is less than 60% by mass; and a ratio (h/Dw) of a thickness (h) of the coating layer to a weight average particle diameter (Dw) of the carrier is more than 0.01, and
wherein an amount of the releasing agent present in a region from a surface of the toner to a depth of 0.3 μm is less than 4% by mass as measured through Fourier transform infrared-attenuated total reflection (FTIR-ATR) spectroscopy,
Si(R¹)ₐ(R²)₄₋ₐ General Formula (1)
wherein R¹ represents an alkyl group having 1 to 10 carbon atoms; R² represents an alkoxy group having 1 to 10 carbon atoms, alkenyloxy group having 1 to 10 carbon atoms, acyloxy group having 1 to 10 carbon atoms or alkoxyalkoxy group having 1 to 10 carbon atoms; and a is an integer of 0, 1 or 2.

15. The two-component developer according to claim 14, wherein the binder resin contained in the toner is a polyester resin.

16. The two-component developer according to claim 14, wherein the binder resin contains a modified polyester having a substituent whose end can react with an active hydrogen-containing group.

17. The two-component developer according to claim 14, wherein the releasing agent is a wax; an amount of the wax contained in the toner is 1% by mass to 20% by mass as calculated based on a corresponding mass of an amount of heat absorbed by the wax measured through differential scanning calorimetry (DSC); and an amount of the wax present in a region from a surface of the toner to a depth of 0.3 μm is 0.1% by mass or more and less than 4% by mass as measured through Fourier transform infrared-attenuated total reflection (FTIR-ATR) spectroscopy.

18. The two-component developer according to claim 14, wherein the toner has a volume average particle diameter of 3 μm to 8 μm.

19. The two-component developer according to claim 14, wherein the toner has a ratio of a volume average particle diameter to a number average particle diameter (volume average particle diameter/number average particle diameter) of 1.00 to 1.25.

20. An image forming method comprising:
forming a latent electrostatic image on a latent electrostatic image bearing member,
developing the latent electrostatic image with use of a two-component developer to form a visible image,
transferring the visible image onto a recording medium, and
fixing the transferred image on the recording medium,
wherein the two-component developer comprises
a carrier which comprises core particles composed of a magnetic material and a coating layer formed on surfaces of the core particles,
a toner which is produced through aqueous granulation and contains at least a colorant, a binder resin and a releasing agent,
wherein the coating layer is formed by applying a coating liquid containing at least colloidal silica, a condensate of alkoxysilane represented by the following General Formula (1) and a solvent onto the surfaces of the core particles; an amount of colloidal silica contained in the coating layer is less than 60% by mass; and a ratio (h/Dw) of a thickness (h) of the coating layer to a weight average particle diameter (Dw) of the carrier is more than 0.01, and
wherein an amount of the releasing agent present in a region from a surface of the toner to a depth of 0.3 μm is less than 4% by mass as measured through Fourier transform infrared-attenuated total reflection (FTIR-ATR) spectroscopy,
Si(R¹)ₐ(R²)₄₋ₐ General Formula (1)
wherein R¹ represents an alkyl group having 1 to 10 carbon atoms; R² represents an alkoxy group having 1 to 10 carbon atoms, alkenyloxy group having 1 to 10 carbon atoms, acyloxy group having 1 to 10 carbon atoms or alkoxyalkoxy group having 1 to 10 carbon atoms; and a is an integer of 0, 1 or 2.
